(19) United States
(12) Patent Application Publication
(10) Pub. No.: US 2012/0246471 A1
(43) Pub. Date: Sep. 27, 2012

(54) INFORMATION PROCESSING DEVICE, INFORMATION PROCESSING SYSTEM, DISTRIBUTION METHOD, AND PROGRAM THEREOF

(75) Inventors: Minoru OZAKI, Fukuoka (JP); Kiyoshi Toyoda, Fukuoka (JP)

(73) Assignee: PANASONIC CORPORATION, Osaka (JP)

(21) Appl. No.: 13/427,637

(22) Filed: Mar. 22, 2012

(30) Foreign Application Priority Data
Mar. 25, 2011 (JP) 2011-067765

(51) Int. Cl. G06F 17/30; H04L 9/00

(52) U.S. Cl. 713/165; 707/679; 707/E17.01; 707/E17.032

(57) ABSTRACT

In order to assure security of classified information, in present invention, before data take-out, third and fourth distributed data are created from first and second distributed data, the first and the second distributed data are saved in a server, and the third and the fourth distributed data are used in take-out.

### BACKGROUND

1. Field of the Invention

The present invention relates to an information processing device, an information processing system, a distribution method, and a program thereof for managing classified information.

2. Description of the Related Art

In recent years, employees of companies, and the like have had a growing awareness of countermeasures against information leakage thanks to the influence of the Personal Information Protection Act. With the propagation of information processing devices such as notebook PCs (Personal Computers), PDAs (Personal Digital Assistants), and the like, it has become usual for employees to work outside their offices using such information processing devices for their duties, and thus, there are many cases where important data about customer information or classified information or even information processing devices storing such important data are lost or stolen.

For this reason, there is a method of dividing and storing classified information as a measure for cases where an information processing device is lost or stolen, and for example, the classified information management system disclosed in Patent Document 1 has been known.

In the classified information management system disclosed in Patent Document 1, classified information S of a user is divided into a plurality of divided data pieces D(1), D(2), and D(3) using a secret sharing scheme A. In the classified information management system, two divided data pieces D(1) and D(2) out of three divided data pieces are stored in a storage server that is connected to the classified information management system, and the remaining divided data piece D(3) is held in the terminal of the user.

Patent Document 1: Japanese Patent No. 4486851

In Patent Document 1 described above, however, there is no probability of decrypting the classified information S only with the data in the terminal, but when the terminal is lost, there is a probability that a third party who acquires the terminal can restore the classified information S of the user by making access to the storage server based on the divided data piece D(3). Accordingly, it is assumed that the security of the classified information S of the user is not effectively assured.

### SUMMARY

The present invention takes the above-described circumstances of the related art, and aims to provide an information processing device, an information processing system, a distribution method, and a program thereof that assures the security of classified information.

The invention is about the above-described information processing device that can be connected to a server and an external storage medium and includes a distribution unit that generates at least two pieces of distributed data from data in a file or a folder, a restoration unit that restores the data in the file or the folder from at least two pieces of the distributed data, and a storage unit that stores the distributed data, in which, before data take-out, the distribution unit generates first distributed data and second distributed data, and the first distributed data is stored in the storage unit and the second distributed data is stored in the server, and during data take-out, the restoration unit restores the data in the file or the folder from the first distributed data and the second distributed data, the distribution unit generates third distributed data and fourth distributed data from the restored data in the file or the folder, either the information processing device or the server stores the first and the second distributed data and the other stores the third and the fourth distributed data, and the storage unit in the information processing device stores either one piece of the distributed data and the external storage medium stores the other piece thereof.

The invention is about the above-described information processing system that includes an information processing device that can be connected to an external storage medium and includes a distribution unit that generates at least two pieces of distributed data from data in a file or a folder, a restoration unit that restores the data in the file or the folder from at least two pieces of the distributed data, a storage unit that stores the distributed data, and a first transmission unit that transmits the distributed data to the server, and a server that can be connected to the information processing device and a plurality of storage devices, including a second transmission unit that transmits the distributed data to the storage device, in which, before data take-out, the distribution unit generates first distributed data and second distributed data, and stores the first distributed data in the storage unit and the second distributed data in the storage devices via the server, and during data take-out, the restoration unit restores the data in the file or the folder from the first distributed data and the second distributed data, the distribution unit generates third distributed data and fourth distributed data from the restored data in the file or the folder, either the information processing device or the server stores the first and the second distributed data and the other stores the third and the fourth distributed data, and the storage unit in the information processing device stores either one piece of the distributed data and the external storage medium stores the other piece thereof.

The invention is about the above-described distribution method used in an information processing device that includes a distribution unit that generates at least two pieces of distributed data from data in a file or a folder, a restoration unit that restores the data in the file or the folder from at least two pieces of the distributed data, and a storage unit that stores the distributed data, and can be connected to a server and an external storage medium, in which before data take-out, first distributed data and second distributed data are generated, and the first distributed data is stored in the storage unit and the second distributed data is stored in the server, and, during data take-out, the data in the file or the folder is restored from the first distributed data and the second distributed data, third distributed data and fourth distributed data are generated from the restored data in the file or the folder, either the information processing device or the server stores the first and the second distributed data and the other stores the third and the fourth distributed data, and the storage unit in the information processing device stores either one piece of the distributed data and the external storage medium stores the other piece thereof.

According to the invention, it is possible to assure security of classified information.

### BRIEF DESCRIPTION OF DRAWINGS

FIG. 1 is a block diagram showing each internal configuration of an information processing system in detail according to a first embodiment.

FIG. 2 is a block diagram showing an internal configuration of an encoding processing unit in detail.

FIG. 3(a) is a configuration diagram of a map table of the information processing device, FIG. 3(b) is a configuration diagram of a map table stored in a server for each information processing device, and FIG. 3(c) is a schematic diagram showing the state of generating distributed data when a secret sharing scheme is used in the information processing device and the server.

FIG. 4(a) is a schematic diagram of a header added by the encoding processing unit, FIG. 4(b) is a schematic diagram of each distributed data piece generated based on an encoding scheme N, FIG. 4(c) is a schematic diagram of each distributed data piece generated based on an encoding scheme E, and FIG. 4(d) is a schematic diagram of each distributed data piece generated based on an encoding scheme H.

FIG. 5 is a sequence diagram illustrating an encoding process in the information processing device according to the first embodiment of the invention.

FIG. 6 is a sequence diagram illustrating a restoration process in the information processing device according to the first embodiment of the invention.

FIG. 7 is a sequence diagram illustrating an encoding process in a server constituting an information processing system according to the first embodiment of the invention.

FIG. 8 is a sequence diagram illustrating a restoration process in the server constituting the information processing system according to the first embodiment of the invention.

FIG. 9 is a schematic diagram showing the information processing device and a state of the information processing system before taking out re-distributed data.

FIG. 10 is a configuration diagram of a map table stored in the information processing device before taking out the information processing device and the re-distributed data.

FIG. 11 is a schematic diagram showing the state where the information processing device restores the original data.

FIG. 12 is a schematic diagram showing a state of the information processing system when the information processing device and re-distributed data are taken out.

FIG. 13 is a configuration diagram of a map table stored in the information processing device when the information processing device and the re-distributed data are taken out.

FIG. 14 is a schematic diagram showing a state of the information processing system after the information processing device and the re-distributed data are taken back.

FIG. 15 is a configuration diagram of a map table stored in the information processing device after the information processing device and the re-distributed data are taken back.

FIG. 16 is a sequence diagram showing an operation of the information processing system when the information processing device and the re-distributed data are taken out.

FIG. 17 is a flowchart showing an operation of the information processing device when data re-distributed is to be read after the information processing device and the re-distributed data are taken out.

FIG. 18 is a sequence diagram showing an operation of the information processing system after the information processing device and re-distributed data are taken back.

### DETAILED DESCRIPTION

Hereinafter, the information processing device, the information processing system, the distribution method, and the program thereof according to the invention will be described with reference to the drawings. Hereinbelow, description on a notebook PC will be provided as an example of the information processing device according to the invention. However, the information processing device according to the invention is not limited to a notebook PC, but may be a smartphone, a PDA (Personal Digital Assistant), a digital book terminal, or the like.

The invention can be presented as a program for making various devices of a notebook PC operate as a computer, in addition to being presented as an information processing device and an information processing system. Furthermore, the invention can also be presented as a method including a process (step) executed by the notebook PC.

### First Embodiment

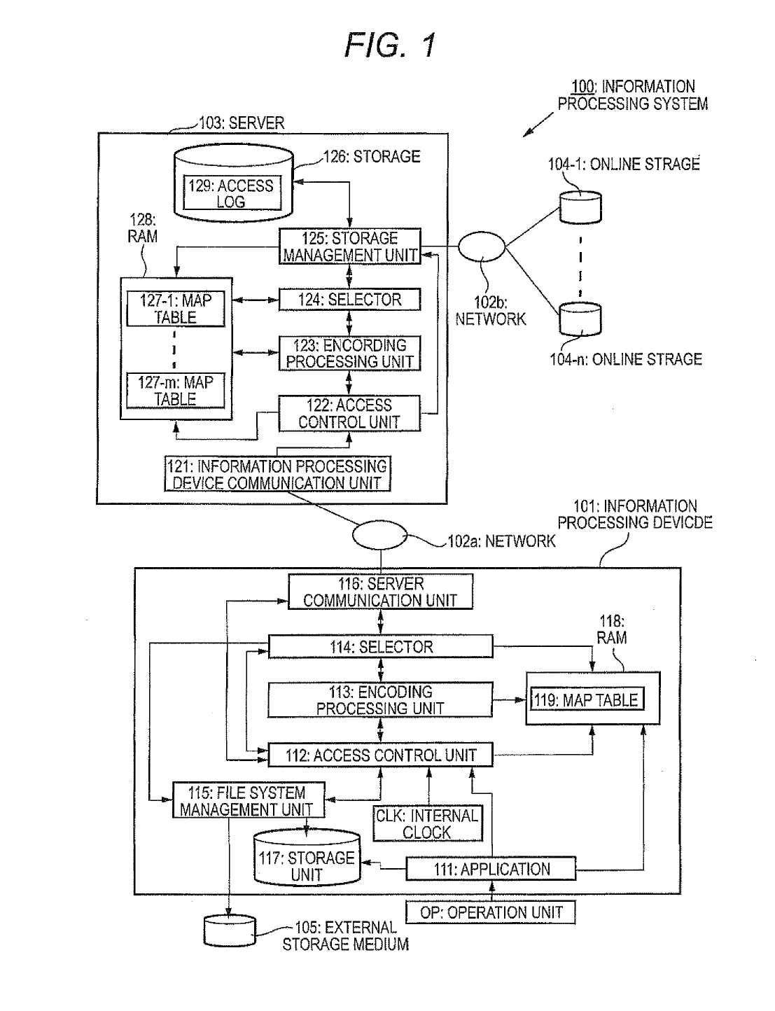

A configuration and an operation of an information processing system 100 according to a first embodiment of the invention will be described with reference to FIGS. 1 to 8.

FIG. 1 is a block diagram showing each internal configuration of the information processing system 100 in detail according to the first embodiment, As shown in FIG. 1, the information processing system 100 includes an information processing device 101, a server 103, and online storages 104-1 to 104-n as a plurality of storage devices.

The information processing device 101 and the server 103 are connected to each other via a network 102a. The network 102a is, for example, an intranet such as an in-house portal site of a company, or the like, a wired network such as the Internet, a wireless network such as a wireless LAN (Local Area Network), or the like.

The server 103 and the online storages 104-1 to 104-n are connected to each other via a network 102b. The network 102b is, for example, an intranet such as an in-house portal site of a company, or the like, a wired network such as the Internet, a wireless network such as a wireless LAN (Local Area Network), or the like.

The information processing device 101 executes various information processes according to the operation of an operating unit OP of a user. The information processing device 101 can be connected to an external storage medium 105, and writes or reads data on or from the external storage medium 105. Furthermore, the operating unit OP is, for example a keyboard, a mouse, or the like that can be connected to the information processing device 101. In addition, the external storage medium 105 is, for example, a USB memory, an SD card, an external HDD, or the like.

A configuration and an operation of the information processing device 101 will be described.

As shown in FIG. 1, the information processing device 101 includes an internal clock CLK, an application 111, an access control unit 112, an encoding processing unit 113, a selector 114, a file system management unit 115, a server communication unit 116, a storage unit 117, and a RAM 118.

The internal clock CLK is a function of an OS (Operating System) that is running, for example, on the information processing device 101 operating as a computer, and is a system clock (timepiece) of the information processing device 101. An output signal of the internal clock CLK, that is, time information of the information processing device 101 is input to the access control unit 112.

The application 111 is installed in the information processing device 101 in advance so as to be made available for use, and instructs operation details according to the operation of the operating unit OP of the user to the access control unit 112. For example, the operation details according to the operation of the operating unit OP of the user is assumed to be an instruction of encoding data in a specific file or folder stored in the storage unit 117.

The application 111 outputs to the access control unit 112 the intent of specifying and encoding the instructed file or the folder according to the operation of the operating unit OP of the user.

The access control unit 112 is input with the output signal from the internal clock CLK and an output signal from the application 111. The access control unit 112 instructs the file system management unit 115 to store a map table 119 that has been stored in the storage unit 117 on the RAM 118 according to the output from the application 111. Furthermore, the file system management unit 115 reads the map table 119 from the storage unit 117 and temporarily stores the table on the RAM 118 according to the instruction.

Furthermore, in the embodiment, the entire map table 119 is developed in the RAM 118, but only information of a file used in the application 111 (part of the map table) may be temporarily stored and used.

The access control unit 112 specifies record of the map table 119 for the instructed file or folder according to the output from the application 111. The access control unit 112 outputs information on the specified record to the encoding processing unit 113.

Furthermore, when there is no record of the map table 119 for the instructed file or folder, the access control unit 112 outputs the intent to the application 111. The application 111 displays the intent of no record of the map table 119 for the instructed file or folder on a display device not shown in the drawing, and notifies the user to promote creation of the record.

Furthermore, when the creation of the record is promoted, it may be possible to let user input all necessary items into the map table 119, or to let the user input part of the items and to allow the information processing device 101 to automatically determine the remaining items.

For the notification, an operation detail according to the operation of the operating unit OP by the user is set to the instruction for adding a record to the map table 119 with respect to a file or a folder. The operation signal is set to include various kinds of information necessary for the record.

The application 111 outputs to the access control unit 112 the instruction for adding a record to the map table 119 for the instructed file or folder according to the operation of the operating unit OP of the user.

The access control unit 112 adds the record of the map table 119 for the instructed file or folder to the map table 119 stored in the RAM 118. Accordingly, the map table 119 is updated.

Furthermore, the access control unit 112 outputs to the server communication unit 116 an identification ID for identifying the information processing device 101 and content of the added record at the same time with the updating of the map table 119. The server control unit 116 transmits the identification ID and the content of the added record to the server 103.

Furthermore, the server 103 updates a map table for the identification ID transmitted from the information processing device 101 with the content of the added record. Furthermore, the identification ID of the information processing device 101 may be, for example, held by the server communication unit 116 in advance, or may be held by other respective units in advance and then acquired by the server communication unit 116 from the units. Furthermore, the above-described updating of the map table 119 is about the addition of a record, but in regard to deletion of a record, a deletion process is executed after transmitting deletion information from the information processing device 101 to the server 103 in the same manner,

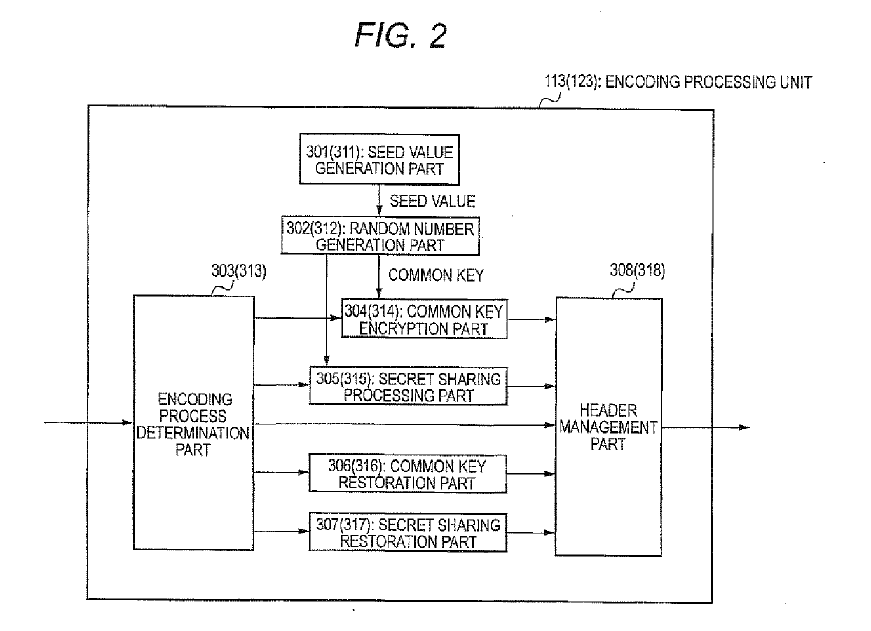

FIG. 2 is a block diagram showing an internal configuration of the encoding processing unit 113 (or 123) in detail. In regard to description of FIG. 2, as the encoding processing unit 113 of the information processing device 101 and an encoding processing unit 123 of the server 103 have the same configuration, the encoding processing unit 113 of the information processing device 101 will be described hereinbelow. Furthermore, in the description below, the encoding processing unit 113 (or 123) indicates the encoding processing unit 113 in the case of the information processing device 101 and indicates the encoding processing unit 123 in the case of the server 103.

As shown in FIG. 2, the encoding processing unit 113 includes a seed value generation part 301, a random number generation part 302, an encoding process determination part 303, a common key encryption part 304, a secret sharing processing part 305, a common key restoration part 306, a secret sharing restoration part 307, and a header management part 308.

The encoding processing unit 113 is input with information of a specified record of the map table 119 from the access control unit 112. The encoding processing unit 113 determines each encoding scheme for the information processing device 101 and the server 103 referring to the input record, and performs encoding of data to be encoded according to the determined encoding scheme for the information processing device 101.

Furthermore, the encoding processing unit 113 determines an encoding scheme to be used based on the information from the access control unit 112, but may determine based on information of a header to be described later.

The encoding processing unit 113 performs a common key encryption process or a secret sharing process as an encoding process. Furthermore, in the information processing device 101 and the server 103, an algorithm of the secret sharing process is not particularly limited, but in the description below, for example, a known (k, n) threshold value secret sharing scheme that is disclosed in referential Non-Patent Document 1 described below is set to be used. In the description below, the parameter k=2, and the parameter n=2.

Referential Non-Patent Document 1: “How to share a secret” by A. Shamir, Communications of the ACM, 22, 11, pp. 612-613 (1979)

The seed value generation part 301 generates an initial value (seed value) necessary for generating a random number used in the common key encryption process or the secret sharing process every time the process is performed. The seed value generation part 301 inputs the generated seed value to the random number generation part 302.

The random number generation part 302 generates a random number based on the output value (seed value) from the seed value generation part 301. The random number generation part 302 outputs the generated random number to the common key encryption part 304 and the secret sharing processing part 305 respectively. The random number is used as a common key in the common key encryption part 304, or used in the secret sharing processing part 305.

The encoding process determination part 303 determines details of the encoding process for the instructed file or folder according to the output from the access control unit 112. The output signal from the access control unit 112 includes information on the record of the map table 119 for the instructed file or folder.

Next, the map table 119 stored in the information processing device 101 will be described.

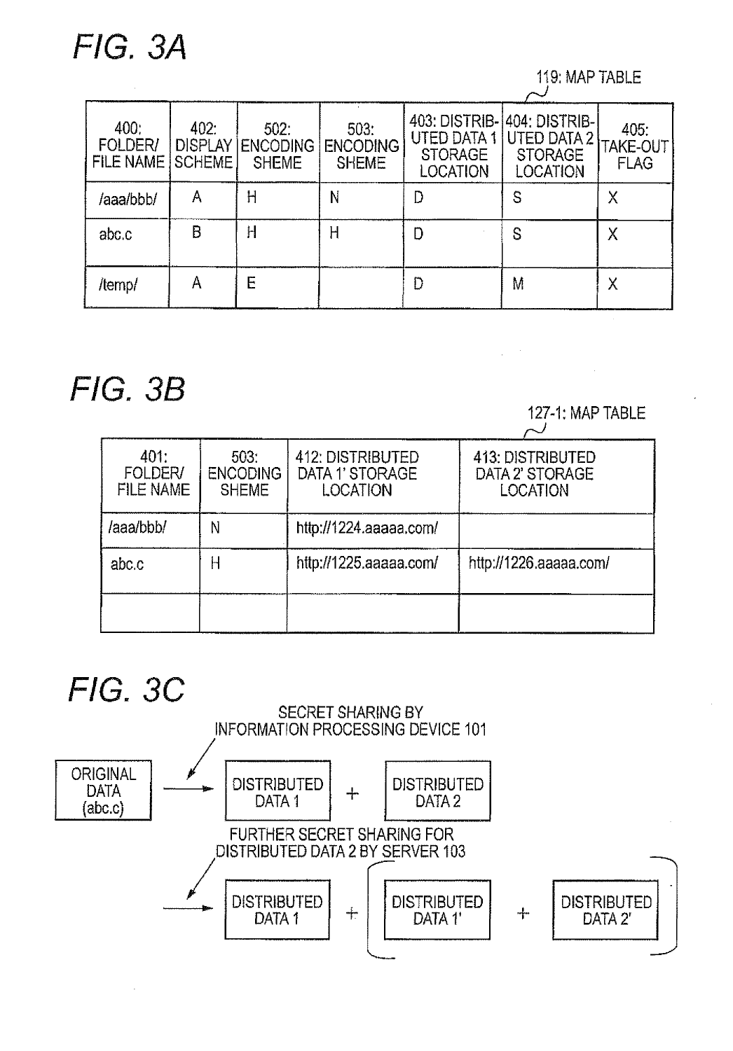

FIG. 3(a) is a configuration diagram of the map table 119 in the information processing device 101. FIG. 3(c) is a schematic diagram showing the state of generating distributed data when the secret sharing process is performed in the information processing device 101 and the server 103. In addition, FIG. 3(b) will be described later.

As shown in FIG. 3(a), the map table 119 includes each item of a folder/file name 401, a display scheme 402, an encoding scheme 502, an encoding scheme 503, a distributed data 1 storage location 403, a distributed data 2 storage location 404, and a take-out flag 405.

That the display scheme 402 is “A” indicates a scheme in which the file system management unit 115 displays on a screen an icon of a file or a folder to be displayed, regardless of the connection state between the information processing device 101 and the server 103 or the external storage medium 105. Thus, even when such a file is not able to be restored without connection between the information processing device 101 and the server 103 or the external storage medium 105, the icon of the file is displayed.

That the display scheme 402 is “B” indicates is a scheme in which the file system management unit 115 does not display the icon of the distributed data in a state where the file or the folder is distributed and then not able to be restored. Thus, if the display scheme 402 is “B”, the icon is displayed when the file or the folder is able to be restored, and the icon is not displayed when the file or the folder is not able to be restored.

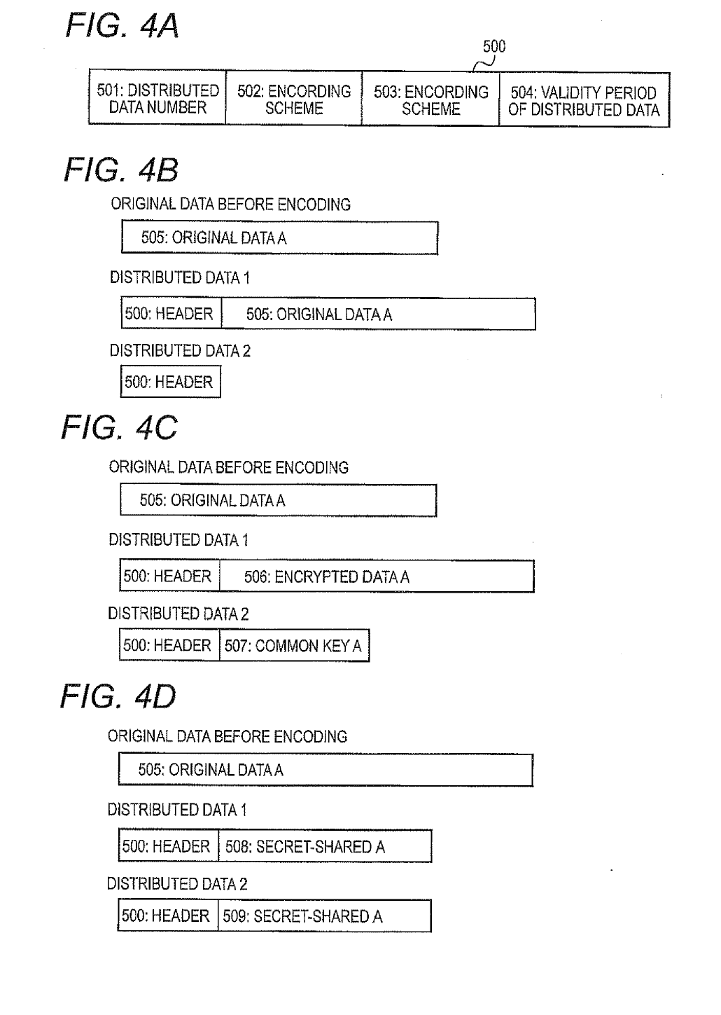

The encoding scheme 502 shows details of the encoding process by the encoding processing unit 113 in the information processing device 101. FIG. 4(b) is a schematic diagram of each distributed data piece generated based on an encoding scheme N. FIG. 4(c) is a schematic diagram of each distributed data piece generated based on an encoding scheme E. FIG. 4(d) is a schematic diagram of each distributed data piece generated based on an encoding scheme H.

As shown in FIG. 4(b), the encoding scheme N indicates not performing the encoding process, and the encoding process unit 113 distributes original data A505 to be encoded into distributed data 1 and distributed data 2. The distributed data 1 is constructed to include a header 500 added by the header management part 308, and the original data A505. The distributed data 2 is constructed to include the header 500 added by the header management part 308 and empty data.

As shown in FIG. 4(c), the encoding scheme E indicates performing the common key encryption process, and the encoding process unit 113 distributes the original data A505 to be encoded into distributed data 1 and distributed data 2. The distributed data 1 is constructed to include the header 500 added by the header management part 308, and an encrypted data A506 that has undergone the common key encryption process. The distributed data 2 is constructed to include the header 500 added by the header management part 308, and the common key that has been used in the common key encryption process.

As shown in FIG. 4(d), the encoding scheme H indicates performing the secret sharing process, and the encoding processing unit 113 performs the secret sharing process for the original data A505 to be encoded into distributed data 1 and distributed data 2. The distributed data 1 is constructed to include the header 500 added by the header management part 308, and secret sharing data A508 that has undergone the secret sharing process. The distributed data 2 is constructed to include the header 500 added by the header management part 308, and secret sharing data A509 that has undergone the secret sharing process.

The encoding scheme 503 indicates the details of the encoding process by the encoding processing unit 123 in the server 103. Since the details of each encoding scheme (N, E, and H) in the encoding scheme 503 are the same as those of each encoding scheme (N, E, and H) in the encoding scheme 502, description thereof will not be repeated.

The distributed data 1 storage location 403 indicates the location where the distributed data 1 is stored, and specifically, can be identified by three types of a parameter D, a parameter S, and a parameter M. The parameter D indicates that the distributed data 1 is stored in the storage unit 117 of the information processing device 101. The parameter S indicates that the distributed data 1 is stored in the server 103. Thus, when the distributed data 1 storage location 403 is the parameter S, the information processing device 101 just recognizes that the distributed data 1 is stored in the server 103, and is not able to specifically recognize that the data is saved in a form such as being saved in the online storages, or the like. The parameter M indicates that the distributed data 1 is stored in the external storage medium 105. In addition, the same is applied to the distributed data 2 storage location 404.

The take-out flag 405 is information indicating, for example, whether or not the user has left the office with data of the file.

For example, when an operation of taking out the data is performed for the application 111 according to the operation of the operating unit OP of the user, the access control unit 112 updates the take-out flag 405 with “O” or “ON” according to the output from the application 111.

In addition, when an operation of bringing back the distributed data 1 or the distributed data 2 from outside of the office is performed for the application 111 according to the operation of the operating unit OP of the user, the access control unit 112 updates the take-out flag 405 with “X” or “OFF” according to the output from the application 111.

Furthermore, as shown in FIG. 3(a), the file “abc.c” undergoes by the secret sharing scheme in the information processing device 101 and the server 103. As shown in FIG. 3(c), original data of the file “abc.c” undergoes secret sharing by the encoding processing unit 113 of the information processing device 101, and then two pieces of the distributed data 1 and the distributed data 2 are generated.

Furthermore, the distributed data 2 undergoes secret sharing by the encoding processing unit 123 of the server 103, and two pieces of distributed data 1′ and distributed data 2′ are generated.

In addition, as shown in FIG. 3(a), since data of the folder “/aaa/bbb/” is not divided by the secret sharing scheme, or the like in the server 103, the distributed data 2 transmitted from the information processing device 101 is set to the distributed data 1′ without change.

The common key encryption part 304 performs the common key encryption process for data of record specified by the access control unit 112 that can be identified in the folder/file name 401 using the random number generated by the random number generation part 302 as the common key. The common key encryption part 304 outputs the encrypted data A506 to the header management part 308.

The secret sharing processing part 305 performs the secret sharing process for data of the record specified by the access control unit 112 that can be identified in the folder/file name 401 using the random number generated by the random number generation part 302. The secret sharing processing part 305 outputs to the header management part 308 two pieces of the distributed data A508 and A509 generated in the secret sharing process.

The common key restoration part 306 performs a restoration (decryption) process for the original data A505 from two pieces of the distributed data A506 and A507 (refer to FIG. 4(C)) using the same random number used in the encryption in the common key encryption part 304 as a common key. The common key restoration part 306 outputs the original data A505 that has been restored to the header management part 308.

The secret sharing restoration part 307 performs a (secret sharing) restoration process to restore the two pieces of the distributed data A508 and A509 (refer to FIG. 4(d)) to the original data A505. The secret sharing restoration part 307 outputs the original data A505 that has been restored to the header management part 308.

The header management part 308 is input with the original data A505 that has not been encoded in the encoding processing unit 113, the distributed data A506 and A507 output from the common key encryption part 304, or distributed data A508 and A509 output from the secret sharing processing part 305. The header management part 308 adds the header 500 (refer to FIG. 4(a)) to each piece of the input data.

Specifically, the header management part 308 outputs to the selector 114 the distributed data 1 obtained by adding the header 500 to the original data A505 and the distributed data 2 obtained by adding the header 500 to the empty data according to the input of the original data A505 not encoded in the encoding processing unit 113.

In addition, the header management part 308 outputs to the selector 114 the distributed data 1 obtained by adding the header 500 to the distributed data A506 and the distributed data 2 obtained by adding the header 500 to the distributed data A507 according to the input of the distributed data A506 and A507 output from the common key encryption part 304.

In addition, the header management part 308 outputs to the selector 114 the distributed data 1 obtained by adding the header 500 to the distributed data A508 and the distributed data 2 obtained by adding the header 500 to the distributed data A509 according to the input of the distributed data A508 and A509 output from the secret sharing processing part 305.

Furthermore, the header management part 308 outputs to the access control unit 112 only the original data A505, out of the original data A505 output from the common key restoration part 306, or from the secret sharing restoration part 307.

FIG. 4(a) is a schematic diagram of the header given by the header management part 308. The header 500 includes a distributed data number 501, an encoding scheme 502, an encoding scheme 503, and a distributed data validity period 504.

The distributed data number 501 is an identification ID for identifying each piece of distributed data. The distributed data validity period 504 is the validity period of distributed data. The distributed data validity period 504 is set to a predetermined number of days (for example, 3 days) or a date, or can be set to a predetermined duration, or a predetermined time.

Alternatively, when the common key encryption part 304 or the secret sharing processing part 305 performs the common key encryption process or the secret sharing process, the distributed data validity period 504 may also be a validity period based on responsive input of the user by causing the display device not shown in the drawing to display an input screen so as to promote the user to input to the distributed data validity period 504.

The selector 114 is input with the distributed data 1 and the distributed data 2 generated by the encoding processing unit 113 or output without being encoded. The selector 114 determines (selects) the distributed data 1 storage location 403 or the distributed data 2 storage location 404 based on the map table 119 stored in the RAM 118.

For example, as shown in FIG. 3(a), the selector 114 determines (selects) the distributed data 1 storage location 403 of the file “abc.c” to be the parameter D, that is, the storage unit 117 of the information processing device 101.

Furthermore, the selector 114 determines the distributed data 2 storage location 404 of the file “abc.c” to be the parameter S, that is, the server 103. Furthermore, since the information processing device 101 transmits the distributed data 2 to the server 103, the information processing device 101 stores in the map table 119 that the data is saved in the server 103, but since the data is not supposed to be saved in the server 103 in the embodiment, the distributed data 2 is stored in any online storage among the online storages 104-1 to 104-m, and the location is determined to be the server 103. in other words, the information processing device 101 only determines that the data is saved in the server 103, and does not know whether the data is stored in any online storage among the plurality of online storages.

Furthermore, in the embodiment, the distributed data is set to be saved in the online storages 104-1 to 104-m not in the server 103, but one out of the online storages 104-1 to 104-m may be integrated with the server 103, or the data may be stored in the main body of the server 103.

The selector 114 outputs each piece of the distributed data to the file system management unit 115 or the server communication unit 116 according to the determined (selected) distributed data 1 storage location 403 and distributed data 2 storage location 404.

Furthermore, in the embodiment, the selector 114 selects a storage location referring to the distributed data 1 storage location 403 and distributed data 2 storage location 404 on the map table 119, but each of the distributed data storage locations may be stored in the header 500 so that the selector 114 can be operated based on the distributed data storage locations in the header 500.

When there is an instruction of reading the map table 119 from the access control unit 112, the file system management unit 115 reads the map table 119 from the storage unit 117, and stored the table in the RAM 118. Furthermore, in FIG. 1, an arrow indicating control of storing the map table 119 from the file system management unit 115 to the RAM 118 is omitted.

According to a reading instruction or a writing instruction of the distributed data 1 or the distribute data 2 from the selector 114, the file system management unit 115 reads the distributed data 1 or the distribute data 2 from or on a predetermined folder of the storage unit 117. Furthermore, the predetermined folder can be appropriately changed according to an operation of the operating unit OP of the user.

The server communication unit 116 functions as an interface for communication with the server 103. The server communication unit 116 transmits the distributed data 1 or the distributed data 2 and the identification ID of the information processing device 101 to the server 103 via the network 102a according to an instruction of transmitting the distributed data 1 or the distributed data 2 to the server 103 from the selector 114.

In addition, the server communication unit 116 outputs the distributed data to the selector 114 when the distributed data is received from the server 103.

The storage unit 117 is a storage device available for free reading and writing of data, and stores programs executed by the application 111, the access control unit 112, the encoding processing unit 113, the selector 114, and the file system management unit 115 and various kinds of data used in the programs.

In addition, the storage unit 117 stores the map table 119. Moreover, FIG. 1 shows a state where the map table 119 is read from the storage unit 117 and temporarily stored in the RAM 118.

Furthermore, the application 111, the access control unit 112, the encoding processing unit 113, the selector 114, and the file system management unit 115 can be configured by hardware or software. Particularly, when each of the units are configured by software, each of the units can be operated in such a way that a CPU (Central Processing Unit) incorporated in the information processing device 101 reads each program in which each operation of each unit is prescribed in advance from the storage unit 117.

The RAM 118 is used as a work memory in each operation of each unit of the information processing device 101, and temporarily stores the map table 119 that the file system management unit 115 reads from the storage unit 117, for example, according to an output of the access control unit 112.

A configuration and an operation of the server 103 will be described.

As shown in FIG. 1, the server 103 includes an information processing device communication unit 121, an access control unit 122, the encoding processing unit 123, a selector 124, a storage management unit 125, a storage 126, and a RAM 128. Hereinbelow, description on the configuration and operation of the server 103 that are the same as those of the information processing device 101 will not be repeated.

The information processing device communication unit 121 functions as an interface for communicating with a plurality of information processing devices, and receives the distributed data 1 and the distributed data 2 transmitted from the server communication unit 116 and the identification ID of the information processing device 101. The information processing device communication unit 121 outputs the received distributed data 1 and the distributed data 2 the identification ID of the information processing device 101 to the access control unit 122.

The information processing device communication unit 121 receives from (the server communication unit 116 of) the information processing device 101 the identification ID of the information processing device 101 and the content of record of the map table added or deleted when the map table 119 is updated in the information processing device 101. The information processing device communication unit 121 outputs to the access control unit 122 the identification ID of the information processing device 101 and the content of record of the map table added or deleted.

The access control unit 122 instructs the storage management unit 125 to have the RAM 128 to store a map table corresponding to the identification ID of the information processing device 101 among each map table stored for each piece of information processing device in the storage 126 according to an output from the information processing device communication unit 121. Furthermore, the storage management unit 125 reads the map table (of which the reference numeral is set to 127-1) corresponding to the identification ID of the information processing device 101 from the storage 126 according to the instruction, and has the RAM 128 to temporarily store the map table.

The access control unit 122 specifies record of the map table 127-1 for the instructed file or folder according to an output from the information processing device communication unit 121. The access control unit 122 outputs information on the specified record to the encoding processing unit 123.

As shown in FIG. 2, the encoding processing unit 123 includes a seed value generation part 311, a random number generation part 312, an encoding process determination part 313, a common key encryption part 314, a secret sharing processing part 315, a common key restoration part 316, a secret sharing restoration part 317, and a header management part 318.

The encoding processing unit 123 is input with the information on the record of the specified map table 127-1 from the access control part 122. The encoding processing part 123 determines an encoding scheme for the server 103 referring to the input record, and performs encoding for data to be encoded following the determined encoding scheme for the server 103.

Furthermore, for example, when the encoding process is not performed in the server 103 as shown in the example of the folder “/aaa/bbb/” of FIG. 3(a), the encoding processing unit 123 outputs to the selector 124 the distributed data 1 or the distributed data 2 output from the access control unit 122, without performing encoding for the data. In addition, the server 103 may be a management server having a function of managing information on the plurality of information processing devices 101 and users thereof, in addition to the above-described functions.

Next, the map table 127-1 stored in the server 103 will be described.

FIG. 3(b) is a configuration diagram of map tables 127-1 to 127-m stored in the server 103 for each information processing device 101. Hereinbelow, in regard to FIG. 3(b), description will be provided for the map table 127-1 corresponding to the identification ID of the information processing device 101.

As shown in FIG. 3(b), the map table 127-1 includes each item of the folder/file name 401, the encoding scheme 503, a distributed data 1′ storage location 412, and a distributed data 2′ storage location 413. Since the folder/file name 401 and the encoding scheme 503 are the same as those in FIG. 3(a), description thereof will not be repeated.

The distributed data 1′ storage location 412 indicates a location where the distributed data 1′ is stored, and specifically, indicates a URI (Uniform

Resource Identifier) that identifies a storage location of an online storage among the online storage 104-1 to 104-n.

Furthermore, when the encoding process is not performed in the server 103 as shown in the example of the folder “/aaa/bbb/” of FIG. 3(a), the distributed data 1′ storage location 412 of FIG. 3(b) indicates a storage location of the distributed data 1′.

When the encoding process is performed in the server 103 as shown in the example of the file “abc.c” of FIG. 3(a), the distributed data 2 that the server 103 receives (refer to FIG. 3(c)) is distributed into the distributed data 1′ and the distributed data 2′ (refer to FIG. 3(c)) in the server 103.

The seed value generation part 311 generates an initial value (seed value) necessary for generating a random number used in a common key encryption process or a secret sharing process every time the process is to be performed. The seed value generation part 311 outputs the generated seed value to the random number generation part 312.

The random number generation part 312 generates a random number based on the output value (seed value) from the seed value generation part 311. The random number generation part 312 outputs the generated random number to the common key encryption part 314 and the secret sharing processing part 315 respectively. The random number is used as a common key in the common key encryption part 314, and used in the secret sharing processing part 315.

The encoding process determination part 313 determines details of the encoding process for the encoded file or folder according to an output from the access control unit 122. The output signal from the access control unit 122 includes information on the record of the map table 127-1 for the encoded file or folder.

The common key encryption part 314 performs the common key encryption process for data that can be identified in the folder/file name 401 on the map table 127-1 specified by the access control unit 122 using the random number generated by the random number generation part 312 as the common key. The common key encryption part 314 outputs encrypted data A506 to the header management part 318.

The secret sharing processing part 315 performs the secret sharing process for data that can be identified in the folder/file name 401 of the record specified by the access control unit 122 using the random number generated by the random number generation part 312. The secret sharing processing part 315 outputs to the header management part 318 two pieces of distributed data A508 and A509 generated in the secret sharing process.

The common key restoration part 316 performs a restoration (decryption) process for original data A505 from two pieces of the distributed data A506 and A507 (refer to FIG. 4(C)) using the same random number used in the encryption in the common key encryption part 314 as the common key. The common key restoration part 316 outputs the original data A505 that has been restored to the header management part 318.

The secret sharing restoration part 317 performs a (secret sharing) restoration process to restore the two pieces of the distributed data A508 and A509 (refer to FIG. 4(d)) to the original data A505 based on the same random number used during the secret sharing process in the secret sharing processing part 315. The secret sharing restoration part 317 outputs the original data A505 that has been restored to the header management part 318.

The header management part 318 is input with the original data A505 that has not been encoded in the encoding processing unit 123, the distributed data A506 and A507 output from the common key encryption part 314, or the distributed data A508 and A509 output from the secret sharing processing part 315. The header management part 318 adds the header 500 (refer to FIG. 4(a)) to each piece of the input data.

Furthermore, the original data A505 in the server 103 is data received from the information processing device 101, and includes encrypted data and distributed data according to an encoding processing method of the information processing device 101.

Specifically, the header management part 318 outputs to the selector 124 the distributed data 1′ obtained by adding the header 500 to the original data A505 and the distributed data 2′ obtained by adding the header 500 to the empty data according to the input of the original data A505 that has not been encoded in the encoding processing unit 123.

In addition, the header management part 318 outputs to the selector 124 the distributed data 1′ obtained by adding the header 500 to the distributed data A506 and the distributed data 2′ obtained by adding the header 500 to the distributed data A507 according to the input of the distributed data A506 and A507 output from the common key encryption part 314.

In addition, the header management part 318 outputs to the selector 124 the distributed data 1′ obtained by adding the header 500 to the distributed data A508 and the distributed data 2′ obtained by adding the header 500 to the distributed data A509 according to the input of the distributed data A508 and A509 output from the secret sharing processing part 315.

Furthermore, the header management part 318 outputs to the access control unit 122 only the original data A505 output from the common key restoration part 316, the secret sharing restoration part 317, or the encoding process determination part 303.

The selector 124 is input with the distributed data 1′ and the distributed data 2′ output without being generated or encoded by the encoding processing unit 123. The selector 124 determines (selects) a distributed data 1′ storage location 412 and a distributed data 2′ storage location 413 based on the map table 127-1 stored in the RAM 128.

For example, the selector 124 determines (selects) the distributed data 1′ storage location of the file “abc.c” to be “http://1225.aaaaa.com/” as shown in FIG. 3(b).

Furthermore, the distributed data 1′ of the file “abc.c” is stored in the storage unit 117 of the information processing device 101. The distributed data 1′ generated from secret sharing for the distributed data 2 of the file “abc.c” by the encoding processing unit 123 is stored in an online storage that can be specified by the URI “http://1225.aaaaa.com/” among the online storages 104-1 to 104-n.

In addition, the selector 124 determines (selects) the storage location of the distributed data 2′ of the file “abc.c” to be, for example, “http://1226.aaaaa.com/” as shown in FIG. 3(b).

The distributed data 2′ generated from secret sharing for the distributed data 2′ of the file “abc.c” by the encoding processing unit 123 is stored in an online storage that can be specified by the URI “http://1226.aaaaa.com/” among the online storages 104-1 to 104-n.

The selector 124 outputs each piece of the distributed data to the storage management unit 125 according to each storage location of each piece of the determined (selected) distributed data.

When there is an instruction of reading the map table 127-1 from the access control unit 122, the storage management unit 125 reads the map table 127-1 corresponding to the identification ID of the information processing device 101 from the storage 126 and have the RAM 128 store the table.

The storage management unit 125 reads or writes the distributed data from or to an online storage among the online storages 104-1 to 104-n, that is, the storage location determined (selected) by the selector 124 according to a reading or writing instruction of the distributed data from the selector 124.

When the storage management unit 125 writes or reads the distributed data on or from the online storage among the online storages 104-1 to 104-n, the detailed access to the online storage is stored in the storage 126 as an access log 129.

The storage 126 is a storage device available for free reading and writing of data, and stores programs executed by the access control unit 122, the encoding processing unit 123, the selector 124, and the storage management unit 125 and various kinds of data used in the programs.

In addition, the storage 126 stores the map tables 127-1 to 127-m. Furthermore, FIG. 1 shows a state where the map tables 127-1 to 127-m are read from the storage 126 and temporarily stored in the RAM 128.

Furthermore, the access control unit 122, the encoding processing unit 123, the selector 124, and the storage management unit 125 can be configured by hardware or software. Particularly, when each of the units is configured by software, each of the units can be operated in such a way that a CPU (Central Processing Unit) incorporated in the server 103 reads each program in which each operation of each unit is prescribed in advance from the storage 126.

The RAM 128 is used as a work memory in each operation of each unit of the server 103, and temporarily stores the map table 127-1 that the storage management unit 125 reads from the storage 126, for example, according to an output of the access control unit 122.

The online storages 104-1 to 104-m is configured with a plurality of online storages (storage devices), and stores distributed data output from the server 103 (or the storage management unit 125). Each of the online storages is the same storage device.

The external storage medium 105 can be configured by, for example, a portable storage medium, a semiconductor memory card, or the like, and stores distributed data output from the file system management unit 115.

The detailed operation of the encoding process and the restoration process of the information processing device 101 will be described.

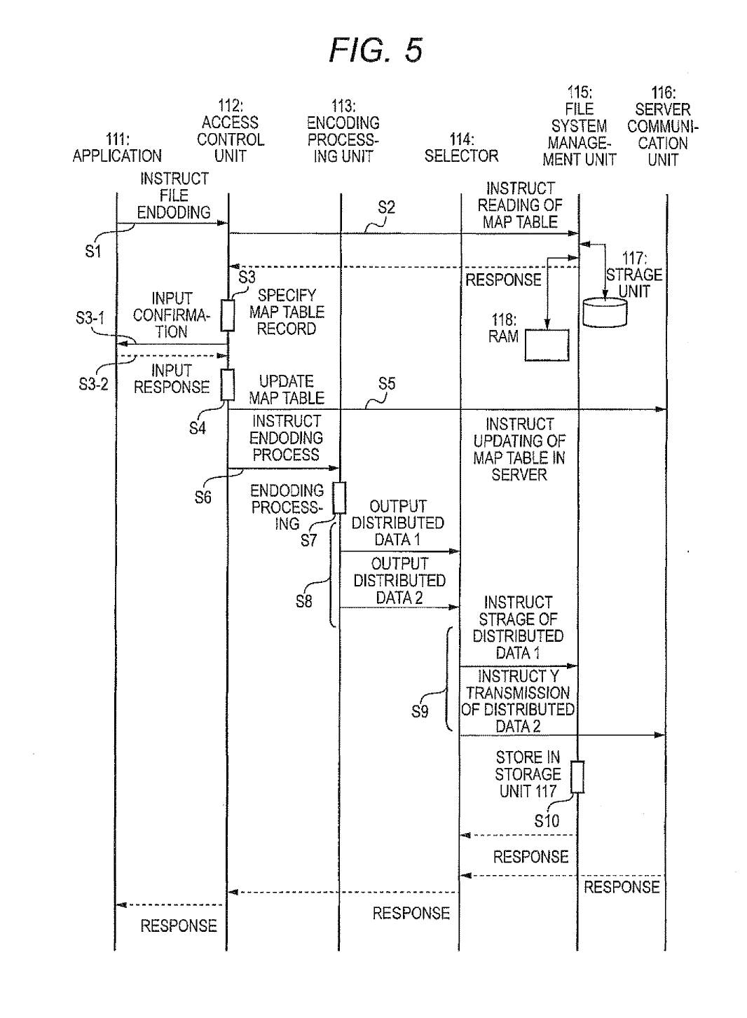

FIG. 5 is a sequence diagram illustrating the encoding process in the information processing device 101 according to the first embodiment. FIG. 5 illustrates an example of encoding, for example, the file “abc.c” of FIG. 3(a) by the information processing device 101 based on the map table 119 of FIG. 3(a) according to an operation of the operating unit OP of the user.

In FIG. 5, the application 111 outputs the intent of specifying the file “abc.c” for which the encoding process is instructed to the access control unit 112 according to an operation of the operating unit OP of the user (S1).

The access control unit 112 instructs the file system management unit 115 to have the RAM 118 store the map table 119 stored in the storage unit 117 according to the output from the application 111 (S2). The file system management unit 115 reads the map table 119 from the storage unit 117 according to the instruction, has the RAM 118 temporarily store the map table, and outputs the intent of having the RAM 118 store the map table 119 to the access control unit 112 (response).

In addition, the access control unit 112 specifies record of the file “abc.c” for which the encoding process is instructed from the map table 119 according to the output from the application 111 of Step S1 (S3).

When the record of the file “abc.c” for which encoding is instructed is not present on the map table 119, the access control unit 112 outputs the intent to the application 111. The application 111 causes the display device not shown in the drawing to display the intent that the record of the file or folder for which encoding is instructed is not present on the map table 119 and notifies the user of the intent so as to promote the user to create the record (S3-1).

Corresponding to the notification, the operation content according to the operation of the operating unit OP of the user is set to the intent of adding the record of the map table 119 to the file or the folder to be encoded. The operation content includes various kinds of information necessary for the record.

The application 111 outputs the intent of adding the record of the map table 119 to the instructed file or folder to the access control unit 112 according to the operation of the operating unit OP of the user (S3-2).

The access control unit 112 adds the record of the map table 119 for the instructed file or folder to the map table 119 stored in the RAM 118. Accordingly, the map table 119 is updated (S4).

Furthermore, the access control unit 112 outputs to the server communication unit 1116 the identification ID for identifying the information processing device 101 and the content of the added record at the same time when the map table 119 is updated (S5). The server communication unit 116 transmits the identification ID and the content of the added record to the server 103.

Furthermore, the server 103 updates the map table corresponding to the identification ID transmitted from the information processing device 101 with the content of the added record. Moreover, the identification ID of the information processing device 101 may be held by, for example, the server communication unit 116 in advance, or may be acquired from each of other units by the server communication unit 116 while the units hold the identification ID in advance. Furthermore, the above-described updating of the map table 119 is about the addition of record, but is the same for the deletion of record.

The above describes a case where there is no record on the map table 119, but when there is record, an encoding process is instructed (S6) as described below after the record is specified (S3).

The access control unit 112 outputs information on the specified record and the instruction of the encoding process to the encoding processing unit 113 (S6).

The encoding processing unit 113 refers to the map table 119 of FIG. 3(a) and performs a secret sharing process for the file “abc.c” specified as a target to be encoded, according to the instruction of the encoding process output in Step S6.

The encoding processing unit 113 outputs to the selector 114 the distributed data 1 and the distributed data 2 each of which includes the header 500 generated by the secret sharing processing part 305 and the header management part 308 (S8). In addition, the header 500 includes the predetermined validity period thereof or the validity periods of the distributed data 1 and the distributed data 2 designate by the user as described above.

The selector 114 determines (selects) each storage location of the distributed data 1 and the distributed data 2 referring to the map table 119 (S9).

Since the storage location of the distributed data 1 is determined (selected) to be the storage unit 117 of the information processing device 101, the selector 114 outputs the distributed data 1 to the file system management unit 115.

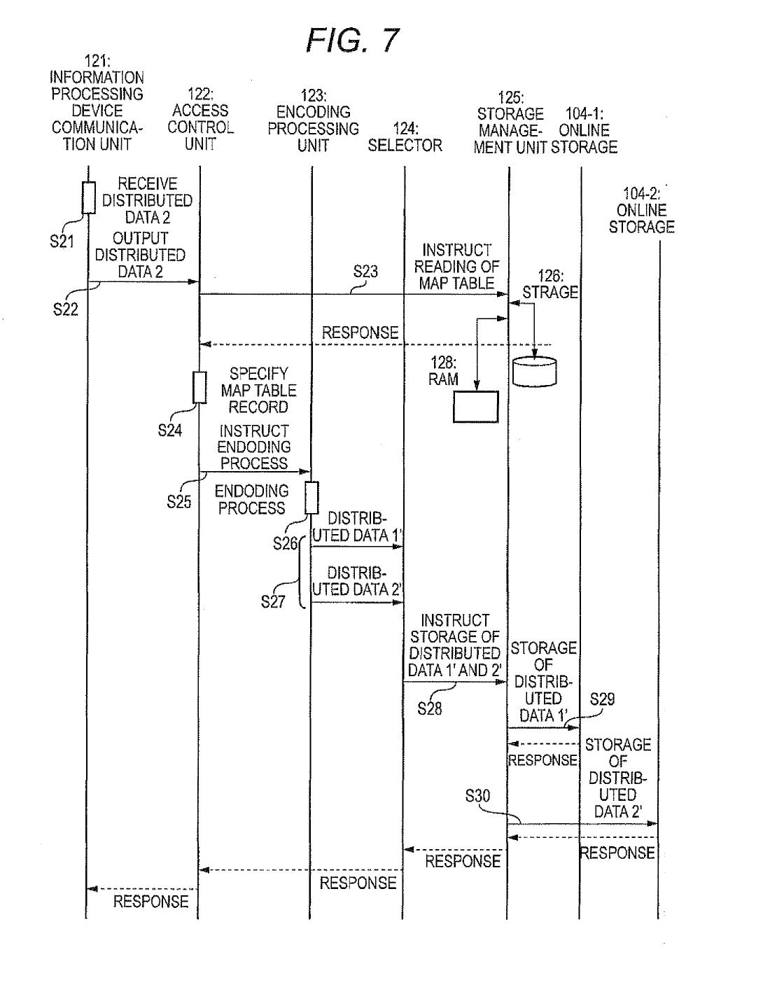

Furthermore, since the storage location of the distributed data 2 is determined (selected) to be the server 103, the selector 114 outputs the distributed data 2 to the server communication unit 116. The server 103 stores the distributed data 2 received from the server communication unit 116 to the online storages. An operation of the server 103 will be described later with reference to FIG. 7.

The file system management unit 115 stores the distributed data 1 output from the selector 114 in a predetermined folder of the storage unit 117 (S10). After Step S10, the file system management unit 115 outputs the intent that the distributed data 1 is stored in the storage unit 117 to the selector 114 (response).

In addition, the selector 114 acquires the intent that the server 103 stores the distributed data 2 from the server communication unit 116 (response). The selector 114 outputs the intent that the distributed data 1 and the distributed data 2 have been stored to the access control unit 112 (response). The access control unit 112 outputs the intent that the distributed data 1 and the distributed data 2 have been stored to the application 111 (response). Accordingly, the application 111 recognizes the intent that the distributed data 1 and the distributed data 2 have been stored. With the above process, the encoding process of the information processing device 101 ends.

Accordingly, when the file “abc.c” is classified information of the user, and even if one piece of distributed data is leaked, the original data is not able to be restored by performing encoding (secret sharing) for the file “abc.c” with the leaked one piece of the distributed data, and therefore, the security of the original data can be assured.

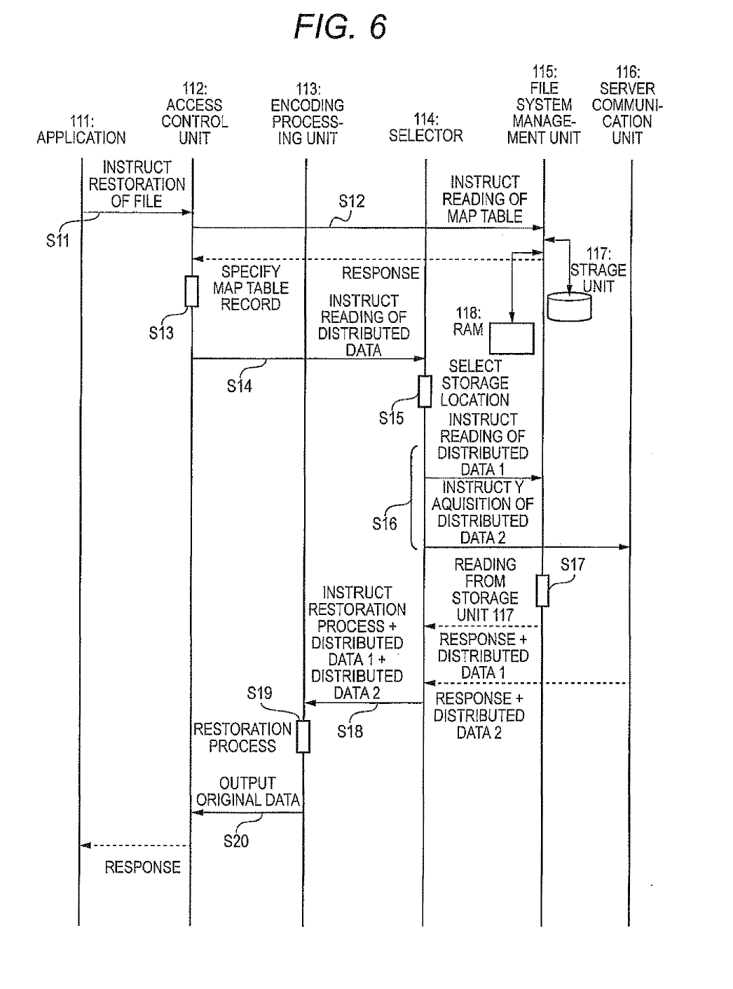

FIG. 6 is a sequence diagram illustrating a restoration process in the information processing device 101 according to the first embodiment. FIG. 6 illustrates an example in which the information processing device 101 performs a restoration process for the original data from each piece of the distributed data of, for example, the file “abc.c” of FIG. 3(a) according to an operation of the operating unit OP of the user.

In FIG. 6, the application 111 outputs to the access control unit 112 the intent of specifying the file “abc.c” of the original data that is instructed to undergo the restoration process according to the operation of the operating unit OP of the user (S11).

The access control unit 112 instructs the file system management unit 115 to have the RAM 118 store the map table 119 stored in the storage unit 117 according to the output from the application 111 (S12). The file system management unit 115 outputs to the access control unit 112 the intent that the RAM 118 stores the map table 119 in such a way that the map table 119 is read from the storage unit 117 and temporarily stored in the RAM 118 according to the instruction (response).

Furthermore, the process of Step S12 described above is performed when the map table 119 is not stored in the RAM 118, and the process is skipped when the map table 119 is stored in the RAM 118.

The access control unit 112 specifies the record of the file “abc.c” for which the restoration process is instructed from the map table 119 according to the output from the application 111 of Step S11.

The access control unit 112 outputs information on the specified record and instruction of reading distributed data to the selector 114 (S14).

The selector 114 determines (selects) each storage location of the distributed data 1 and the distributed data 2 of the file “abc.c” referring to the map table 119 according to the output from the access control unit 112 (S15).

The selector 114 outputs instructions of reading and acquiring each piece of the distributed data from each storage location of the selected distributed data 1 and distributed data 2 to the file system management unit 115 and the server communication unit 116 (S16).

Specifically, since the selector 114 determines (selects) the distributed data 1 storage location 403 to be the storage unit 117 of the information processing device 101, the selector outputs the instruction of reading the distributed data 1 to the file system management unit 115.

Furthermore, since the selector 114 determines (selects) the distributed data 2 storage location 404 to be the server 103, the selector 114 outputs the instruction of acquiring the distributed data 2 to the server communication unit 116.

The file system management unit 115 reads the distributed data 1 from the storage unit 117 (S17) according to the output from the selector 114, and outputs the distributed data 1 to the selector 114 (response +distributed data 1).

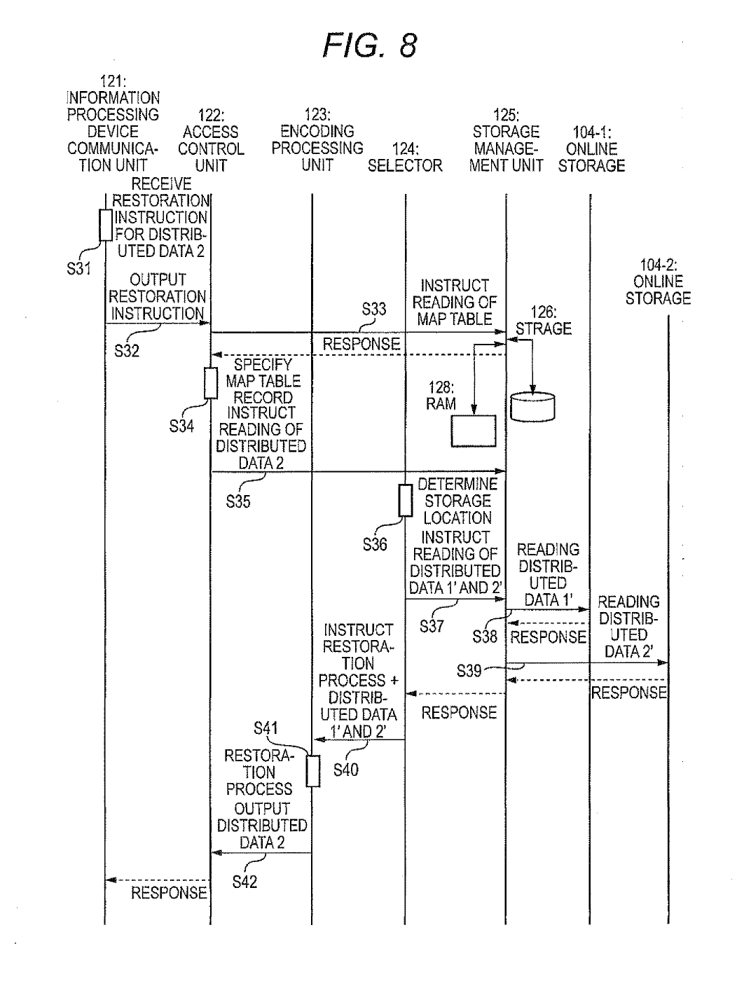

The server communication unit 116 transmits the instruction of acquiring the distributed data 2 to the server 103 according to the output from the selector 114. Furthermore, the server 103 performs the restoration process for the distributed data 2 by an operation shown in FIG. 8 to be described later, and transmits the distributed data 2 to the server communication unit 116. The server communication unit 116 outputs the received distributed data 2 to the selector 114 (response +distributed data 2).

The selector 114 outputs the distributed data 1 and distributed data 2 and a restoration process instruction of the intent of restoring the original data from the distributed data 1 and distributed data 2 to the encoding processing unit 113 (S18).

The encoding processing unit 113 performs the restoration process (secret sharing) (S19) for the distributed data 1 and distributed data 2 of the file “abc.c” specified as a target of the restoration process, referring to the map table 119 of FIG. 3(a), according to the restoration process instruction output in Step S17.

The encoding processing unit 113 outputs the file “abc.c” of the original data that has been restored to the access control unit 112 (S20).

The access control unit 112 outputs to the application 111 the intent that the restoration process for the file “abc.c” of the original data has been completed according to the output from the encoding processing unit 113 (response). Accordingly, the application 111 can use the file “abc.c” of the original data. With the above procedure, the restoration process of the information processing device 101 ends.

FIG. 7 is a sequence diagram illustrating an encoding process in the server 103 constituting the information processing system 100 according to the first embodiment. FIG. 7 illustrates an example in which the information processing device 101 performs a secret sharing process for, for example, the distributed data 2 generated by the secret sharing process of the file “abc.c” of FIG. 3(a) based on the map table 127-1 of FIG. 3(b) according to an operation of the operating unit OP of the user.

In FIG. 7, the information processing device communication unit 121 receives the distributed data 2 and the identification ID of the information processing device 101 transmitted from the server communication unit 116 of the information processing unit 101 (S21). The information processing device communication unit 121 outputs the received distributed data 2 and the identification ID of the information processing device 101 to the access control unit 122 (S22).

The access control unit 122 instructs the storage management unit 125 so as to have the RAM 128 to store the map table 127-1 corresponding to the identification ID of the information processing device 101 among the map tables 127-1 to 127-m stored in the storage 126 according to the output from the information processing device communication unit 121 (S23).

The storage management unit 125 outputs the access control unit 122 the intent of storing the map table 127-1 in the RAM 128 in such a way that the map table 127-1 is read from the storage 126 and temporarily stored in the RAM 128 (response).

The access control unit 122 specifies record of the file “abc.c” for which the encoding process of the distributed data 2 from the map table 127-1 is instructed according to the output from the information processing device communication unit 121 of Step S22 (S24).

The access control unit 122 output information on the specified record and the encoding process instruction to the encoding processing unit 123 (S25).

The encoding processing unit 123 performs the secret sharing process for the fife “abc.c” specified as a target of the encoding process, referring to the map table 127-1 of FIG. 3(b) according to the encoding process instruction output in Step S25 (S26). The distributed data generated by performing the secret sharing process for the distributed data 2 is indicated by the distributed data 1′ and the distributed data 2′ (refer to FIG. 3(c)).

The encoding processing unit 123 outputs to the selector 124 the distributed data 1′ and the distributed data 2′ each including the header 500 generated by the secret sharing processing part 315 and the header management part 318 (S27).

Furthermore, each header 500 of the distributed data 1′ and the distributed data 2′ is set with a predetermined validity period or a validity period added by the header management part 308 of the encoding processing unit 113 of the information processing device 101.

For example, when encoding is performed only in the server 103 not in the information processing device 101, the validity period of the header 500 is preferably set to a predetermined number of days. Furthermore, when encoding is performed both in the information processing device 101 and the server 103, the validity period of the header 500 is preferably set to a validity period added by the header management part 308 of the encoding processing unit 113 of the information processing device 101.

The selector 124 determines (selects) each storage location of the distributed data 1′ and the distributed data 2′ referring to the map table 127-1 (S28).

Since the selector 124 determines (selects) the storage location of the distributed data 1′ to be an online storage corresponding to the URI “http://1225.aaaaa.com/”, the selector outputs the distributed data 1′ to storage management unit 125.

Since the selector 124 determines (selects) the storage location of the distributed data 2′ to be an online storage corresponding to the URI “http://1226.aaaaa.com/”, the selector outputs the distributed data 2′ to storage management unit 125.

The storage management unit 125 stores the distributed data 1′ output from the selector 124 in the online storage corresponding to the URI “http://1225.aaaaa.com/” (S29+response).

The storage management unit 125 stores the distributed data 2′ output from the selector 124 in the online storage corresponding to the URI “http://1226.aaaaa.com/” (S30+response).

In addition, the selector 124 acquires the intent that the distributed data 1′ and the distributed data 2′ are stored in any determined (selected) online storage from the storage management unit 125 (response). The selector 124 outputs the intent that the distributed data 1′ and the distributed data 2′ have been stored to the access control unit 122 (response). The access control unit 122 outputs the intent that the distributed data 1′ and the distributed data 2′ have been stored to the information processing device communication unit 121 (response). Accordingly, the information processing device communication unit 121 transmits the intent that the distributed data 1′ and the distributed data 2′ have been stored to the information processing device 101. With the above procedure, the encoding process in the server 103 ends.

Accordingly, when the file “abc.c” is classified information of the user, and even if the distributed data 1′ and the distributed data 2′ are leaked, the original data is not able to be restored only with the leaked two pieces of the distributed data 1′ and the distributed data 2′ without the distributed data 1 saved in the information processing device 101 by performing further encoding (secret sharing) for the distributed data 2 of the file “abc.c”, and therefore, the security of the original data can be assured.

Furthermore, in order to assure the security for the server 103 when an online storage is selected, it is necessary to select an online storage that is different from one used when the server 103 saves a plurality of distributed data pieces.

FIG. 8 is a sequence diagram illustrating the restoration process in the server 103 constituting the information processing system 100 according to the first embodiment. FIG. 8 illustrates an example where the information processing device 101 restores, for example, the distributed data 2 from the distributed data 1′ and the distributed data 2′ obtained by performing encoding of the file “abc.c” of FIGS. 3(a) and 3(b), according to an operation of the operating unit OP of the user.

In FIG. 8, the information processing device communication unit 121 receives the identification ID of the information processing device 101 and an instruction of the restoration process to the distributed data 2 transmitted from the server communication unit 116 of the information processing device 101 (S31). The information processing device communication unit 121 outputs the instruction of the restoration process to the received distributed data 2 to the access control unit 122 (S32).

The access control unit 122 instructs the storage management unit 125 so as to have the RAM 128 to store the map table 127-1 corresponding to the identification ID of the information processing device 101 among the map tables 127-1 to 127-m stored in the storage 126 according to the output from the information processing device communication unit 121 (S33).

The storage management unit 125 outputs to the access control unit 122 the intent that the RAM 128 stores the map table 127-1 in such a way that the map table 127-1 is read from the storage 126 and temporarily stored in the RAM 128 (response).

Furthermore, the process of Step S33 described above is performed when the map table 127-1 is not stored in the RAM 128, and not performed when the map table 127-1 is stored in the RAM 128.

The access control unit 122 specifies the record of the file “abc.c” for which the restoration process from the map table 127-1 to the distributed data 2 is instructed, according to the output from the information processing device communication unit 121 of Step S31 (S34).

The access control unit 122 outputs to the selector 124 information on the specified record and an instruction of reading the distributed data 2 (S35).

The selector 124 determines (selects) each storage location of the distributed data 1′ and the distributed data 2′ of the file “abc.c” referring to the map table 127-1 according to the output from the access control unit 122 (S36).

The selector 124 outputs to the storage management unit 125 an instruction of reading each piece of distributed data from each of the storage locations of the selected distributed data 1′ and the distributed data 2′ (S37).

The storage management unit 125 reads and acquires the distributed data 1′ from the online storage corresponding to the URI “http://1225.aaaaa.com/” according to the output from the selector 124 (S38+response).

At the same time, the storage management unit 125 reads and acquires the distributed data 2′ from the online storage corresponding to the URI “http://1226.aaaaa.com/” according to the output from the selector 124 (S39+response). The storage management unit 125 outputs the two pieces of the distributed data 1′ and the distributed data 2′ to the selector 124 (response).

The selector 124 acquires the intent of having read the distributed data 1′ and the distributed data 2′ from the storage management unit 125 (response). The selector 124 outputs to the encoding processing unit 123 the distributed data 1′ and the distributed data 2′ and a restoration process instruction for restoring the distributed data 2 from the distributed data 1′ and the distributed data 2′ (S40).

The encoding processing unit 123 performs the restoration process (secret sharing) for the distributed data 1′ and the distributed data 2′ of the file “abc.c” specified as a target to be restored, referring to the map table 127-1 of FIG. 3(b) according to the restoration process instruction output in Step S40 (S41).

The encoding processing unit 123 outputs the distributed data 2 of the restored file “abc.c” to the access control unit 112 (S42).

The access control unit 122 outputs to the information processing device communication unit 121 the intent that the restoration process to the distributed data 2 of the file “abc.c” has been completed and the distributed data 2 according to the output from the encoding processing unit 123 (response). Furthermore, the information processing device communication unit 121 transmits the intent that the restoration process to the distributed data 2 of the file “abc.c” has been completed and the distributed data 2 to the server communication unit 116 of the information processing device 101. In FIG. 6, the transmitted distributed data 2 is equivalent to the distributed data that the server communication unit 116 has received according to the acquirement instruction of the distributed data 2 in Step S15. With the above procedure, the restoration process in the server 103 ends.

Accordingly, the restoration process of the distributed data 2 from the distributed data 1′ and the distributed data 2′ of the file “abc.c” of the original data can be performed, and the restoration process to the original data “abc.c” is shared by the information processing device 101 and the server 103.

In other words, a load of the secret sharing process can be shared by the information processing device 101 and the server 103, and furthermore, security of the original data at the time of restoration can be assured by sharing a scope of holding distributed data.

Furthermore, in the embodiment, when the secret sharing is performed, data is distributed into two pieces, but may be distributed into three or more pieces, and restoration may be performed with a predetermined number (two or more) of distributed data pieces after distributing into three or more pieces,

Herein, a system using the above-described distribution system, for example, an operation of the information processing system 100 in a case where an employee, which is a user, takes out the information processing device 101 and a file of distributed data of a file of data X, which is classified information (original data) of the company, uses the materials outside the office, and then, takes the materials back to the office will be described.

Furthermore, “taking out” mentioned in this embodiment refer to that, when classified information that is required to be connected to the network such as a LAN of a company, or the like is divided and then stored in the information processing device 101 and the server 103, and if the information processing device 101 is taken out of the company so that the device is not able to be connected to the LAN or a network, access can be made to the classified information by storing the information in the information processing device 101 and the external storage medium 105 even when there is no connection to the network.

In this case, when an employee takes out the information processing device 101 and a file of distributed data of the file of data X, which is the classified information of the company, outside the office, the information processing device 101 first performs a restoration process for the data X based on each piece of the distributed data of the data X that has been separately stored.

Furthermore, the information processing device 101 generates re-distributed data X1′ and re-distributed data X2′ again by a secret sharing process for the data X that has undergone the restoration process based on another random number. In addition, since the random number used in the secret sharing process is different, distributed data X1 is different from the re-distributed data X1′ and distributed data X2 is different from re-distributed data X2′.

After all, the data X is not able to be restored other than the two combinations of the distributed data X1 and the distributed data X2 and the re-distributed data X1′ and the re-distributed data X2′

In the end, the employee come to take out the information processing device 101 and the re-distributed data (that is X2′).

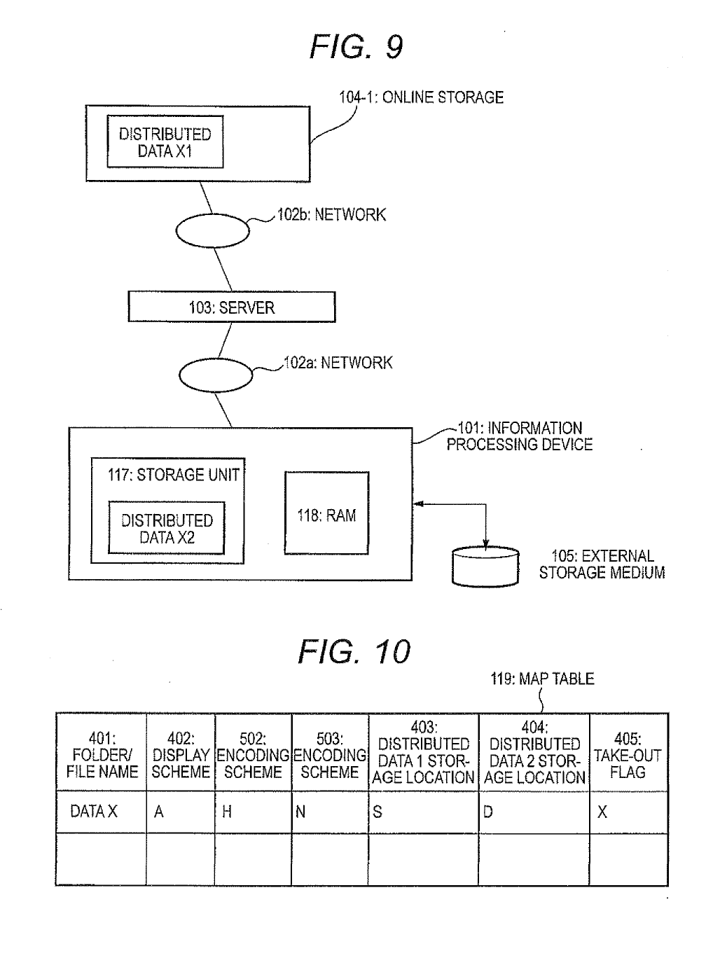

Hereinbelow, the information processing system 100 in take-out will be described referring to FIGS. 9 to 18.

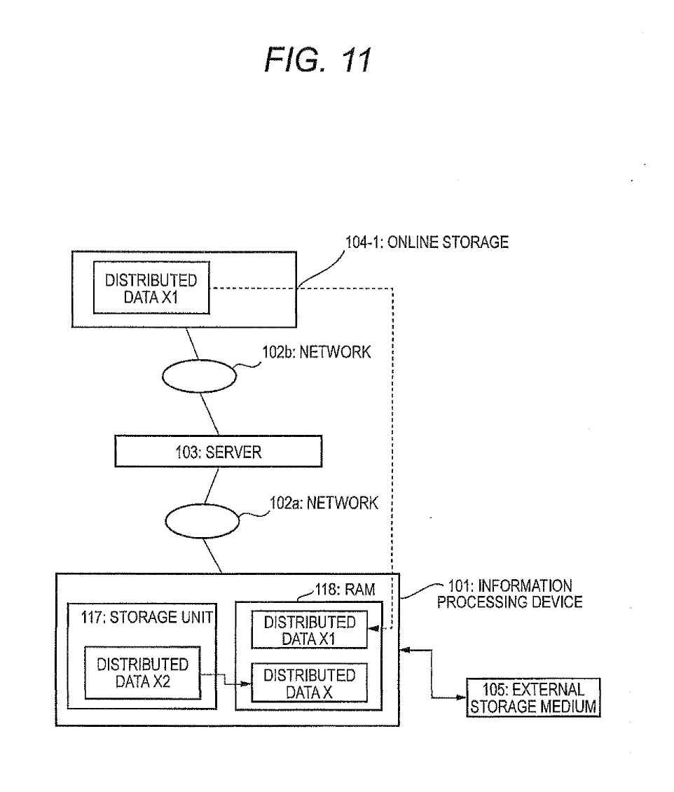

FIG. 9 is a schematic diagram showing the information processing device 101 and a state of the information processing system 100 before taking out re-distributed data. The information processing device 101 shown in FIG. 9 has the same configuration as that of the information processing device 101 shown in FIG. 1, but only the storage unit 117 and the RAM 118 are shown in the drawing for the sake of convenience in description. Hereinbelow, the same is applied to FIGS. 11, 12, and 14. Furthermore, in FIGS. 9, 11, 12, and 14, the map table 119 is assumed to have already been stored in the RAM 118.

FIG. 10 is a configuration diagram of the map table 119 stored in the information processing device 101 before taking out the information processing device 101 and the re-distributed data.

In FIG. 9, the file of the data X in the original data has not been stored in any of the information processing device 101, the online storage 104-1, and the external storage medium 105.

The distributed data X1 of the file of the data X is stored in the online storage 104-1, and the distributed data X2 of the file of the data X is stored in the storage unit 117. In other words, except when an employee uses the data X that is classified information in order to carry out his or her duty within the company, the information processing device 101 generates the distributed data X1 and the distributed data X2 after performing the secret sharing process for the data X by a (2,2) threshold value secret sharing scheme, and stores the data in separate storage locations as described above according to an operation of the operating unit OP of the user.

Each Item of record for the data X on the map table 119 shown in FIG. 10 is as follows. Specifically, the display scheme 402 is determined by the parameter A. The encoding scheme 502 is determined by the parameter H. The encoding scheme 503 is determined by the parameter N.

The distributed data 1 storage location 403 is determined by a parameter S, and the distributed data X1 is stored in the online storage 104-1. The distributed data 2 storage location 404 is determined by a parameter D, and the distributed data X2 is stored in the storage unit 117. Since the file of the distributed data has not been taken out yet at present, the take-out flag 405 is marked with “X”.

FIG. 11 is a schematic diagram showing the state where the file of the data X that is classified information (original data) undergoes the restoration process in the information processing device 101. It is assumed that an operation for taking out the information processing device 101 and re-distributed data of the file of the data X outside the office has been input to the application 111 which is installed in the information processing device 101. Furthermore, with the operation, it is assumed that designation of each storage location and validity period of re-distributed data X1′ and re-distributed data X2′ generated by performing re-distribution after restoration of the file of the data X of the original data has been input thereto.

As described above, the (encoding processing unit 113 of the) information processing device 101 performs the restoration process for the data X based on the distributed data X1 and the distributed data X2 according to the operation.

In other words, as shown in FIG. 11, the information processing device 101 receives the distributed data X1 stored in the online storage 104-1 via the server 103. However, as described above, the information processing device 101 does not know where the distributed data X1 has been stored by the server 103.

Furthermore, the (encoding processing unit 113 of the) information processing device 101 performs the restoration process for the data X based on the received distributed data X1 and the distributed data X2 stored in the storage unit 117. The information processing device 101 stores the data X that has undergone the restoration process in the RAM 118.

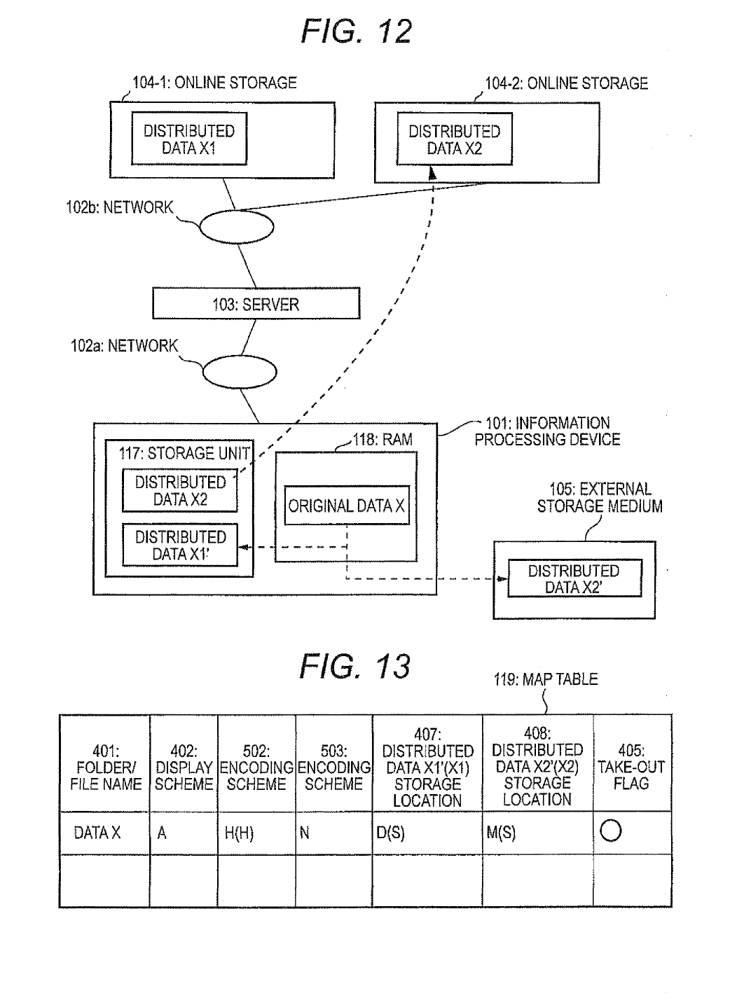

FIG. 12 is a schematic diagram showing a state of the information processing system 100 when the information processing device 101 and re-distributed data are taken out. FIG. 13 is a configuration diagram of the map table 119 stored in the information processing device 101 before the information processing device 101 and the re-distributed data are taken out.

Each item of record for the data X on the map table 119 shown in FIG. 13 is as follows. Specifically, the display scheme 402 is determined by the parameter A. The encoding scheme 502 is determined by the parameter H (H). Furthermore, the letter in the parenthesis indicates a parameter before re-distribution of the original data X described above, and the letter before the parenthesis indicates a parameter after re-distribution of the original data X described above. The encoding scheme 503 is determined by the parameter N.

The distributed data X1′ (X1) storage location 407 is determined by the parameter D(S), the distributed data X1 is stored in the online storage 104-1, and the re-distributed data X1′ is stored in the storage unit 117. Furthermore, the letter in the parenthesis indicates the storage location of the distributed data X1, and the letter in the parenthesis indicates the storage location of the re-distributed data X1′.

The distributed data X2′ (X2) storage location 408 is determined by the parameter M(D), the distributed data X2 is stored in the storage unit 117, and the re-distributed data X2′ is stored in the external storage medium 105. Furthermore, the letter in the parenthesis indicates the storage location of the distributed data X2, and the letter in the parenthesis indicates the storage location of the re-distributed data X2′.

In addition, since it is the time after the operation for taking out the file of the re-distributed data is input, the take-out flag 405 is updated with “O” by the (access control unit 112 of the) information processing device 101.

Furthermore, the details of each item of the record for the data X on the map table 119 of FIG. 10 is updated with the details of each item of the record for the data X on the map table 119 of FIG. 13.

Therefore, as described above, the map table 127-1 of the server 103 is also updated with the details after the above updating at the time when the content of the map table 119 is updated. In other words, the access control unit 122 updates the map table 127-1 in order to differentiate the storage location of the distributed data X1 and the storage location of the distributed data X2.

As described above, it is assumed that the employee has input the operation for taking out the information processing device 101 and the re-distributed data of the data X outside the office to the application 111 that has been installed in the information processing device 101.

According to the operation, the (encoding processing unit 113 of the) information processing device 101 performs the restoration process for the data X (original data) based on the distributed data X1 and the distributed data X2 as described above.

Moreover, as shown in FIG. 12, the (encoding processing unit 113 of the) information processing device 101 performs the secret sharing process (re-distribution process) again for the data X that has undergone the restoration process and generates the re-distributed data X1′ and the re-distributed data X2′ referring to the map table 119. The (encoding processing unit 113 of the) information processing device 101 stores the generated distributed data X1′ and re-distributed data X2′ in the RAM 118.

Furthermore, the (file system management unit 115 of the) information processing device 101 stores the re-distributed data X1′ in the storage unit 117, and the re-distributed data X2′ in the external storage medium 105.

Furthermore, the (selector 114 of the) information processing device 101 determines (selects) the storage location of the distributed data X2 referring to the map table 119, and outputs the distributed data X2 to the server communication unit 116. The (server communication unit 116 of the) information processing device 101 transmits the distributed data X2 to the server 103, and deletes the distributed data X2 that has been stored in the information processing device 101. In addition, the server 103 stores the received distributed data X2 in another online storage 104-2 different from the online storage 104-1 referring to the map table 127-1 updated according to the map table 119 updated by the information processing device 101.

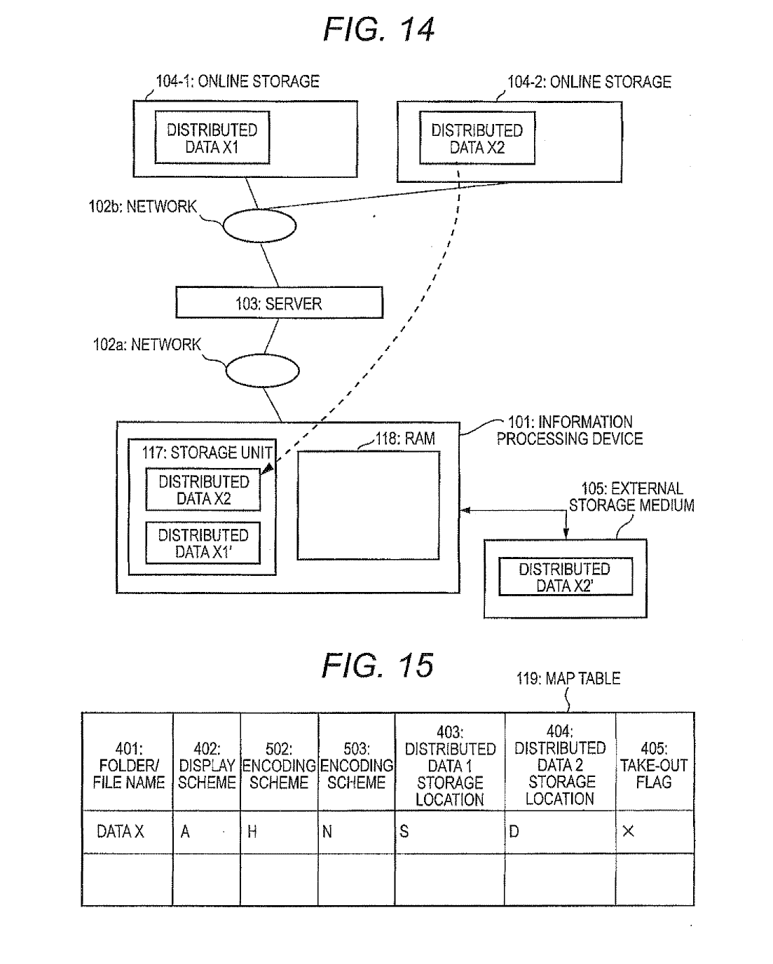

FIG. 14 is a schematic diagram showing a state of the information processing system 100 after the information processing device 101 and the file of the re-distributed data are taken back. FIG. 15 is a configuration diagram of the map table 119 stored in the information processing device 101 after the information processing device 101 and the file of the re-distributed data are taken back.

Each Item of record for the data X on the map table 119 shown in FIG. 15 is as follows. Specifically, the display scheme 402 is determined by the parameter A. The encoding scheme 502 is determined by the parameter H. The encoding scheme 503 is determined by the parameter N.

The distributed data 1 storage location 403 is determined by the parameter 5, and the distributed data X1 is stored in the server 103. In addition, the re-distributed data X1′ is deleted.

The distributed data 2 storage location 404 is determined by the parameter D, and the distributed data X2 is stored in the storage unit 117. In addition, the re-distributed data X2′ is deleted.

In addition, since it is the time after the operation for taking back the file of the re-distributed data is input, the take-out flag 405 is updated with “X” by the access control unit 112.

Furthermore, the details of each item of the record for the data X on the map table 119 of FIG. 13 is updated with the details of each item of the record for the data X on the map table 119 of FIG. 15. Therefore, as described above, the map table 127-1 of the server 103 is also updated with the details after the above updating at the time when the content of the map table 119 is updated. In other words, the access control unit 122 updates the map table 127-1 in order to delete the storage location of the distributed data X2.

As described above, it is assumed that the employee has input the operation for taking back the information processing device 101 and the file of the re-distributed data of the data X outside the office to the application 111 that has been installed in the information processing device 101.

According to the operation, the (file system management unit 115 of the) information processing device 101 reads the re-distributed data X1′ from the storage unit 117 and the re-distributed data X2′ from the external storage medium 105. The (file system management unit 115 of the) information processing device 101 deletes the read re-distributed data X1′ and re-distributed data X2′.

Moreover, as shown in FIG. 14, the (file system management unit 115 of the) information processing device 101 outputs to the server communication unit 116 the intent of acquiring the distributed data X2 from the online storage 104-2. The server communication unit 116 transmits to the server 103 the intent of acquiring the distributed data X2 from the online storage 104-2.

Furthermore, the (storage management unit 125 of the) server 103 reads the distributed data X2 stored in the online storage 104-2, outputs the data to the information processing communication unit 121, and deletes the data from the online storage 104-2. An arrow between the storage management unit 125 and the information processing communication unit 121 is omitted in FIG. 1. The information processing communication unit 121 transmits the distributed data X2 to the information processing device 101.

The (server communication unit 116 of the) information processing device 101 outputs the received distributed data X2 to the file system management unit 115. The (file system management unit 115 of the) information processing device 101 stores the distributed data X2 in the storage unit 117 according to the output from the server communication unit 116.

Operation when the Information Processing Device and the Re-Distributed Data are Taken Out

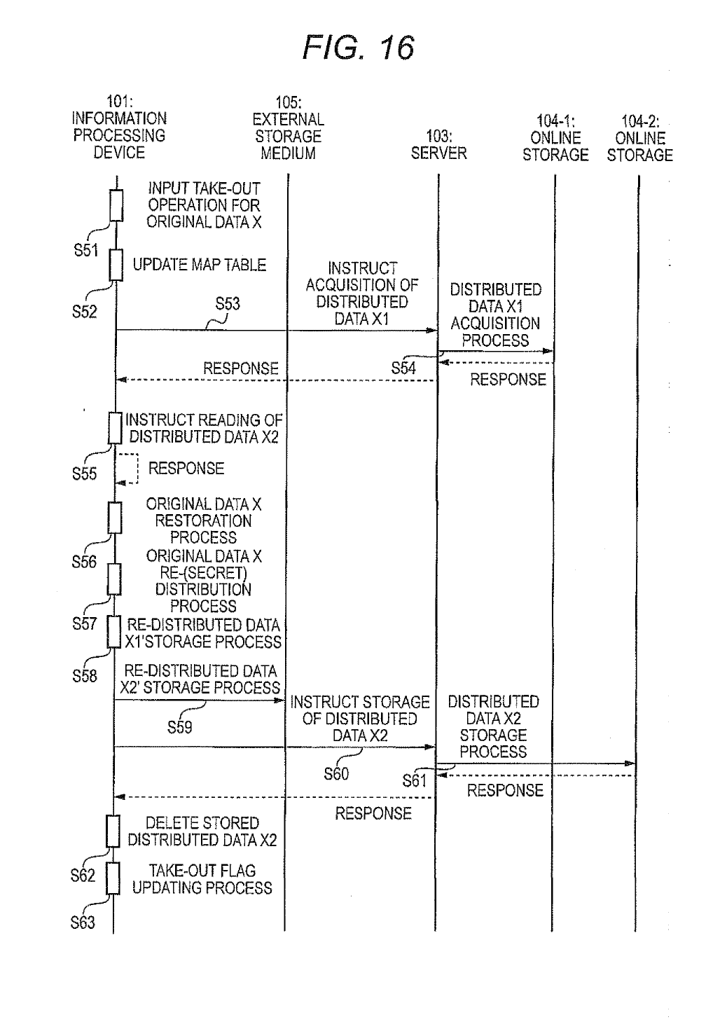

FIG. 16 is a sequence diagram showing an operation of the information processing system 100 when the information processing device 101 and the re-distributed data are taken out.

As a prerequisite for the description on FIG. 16, it is assumed that the distributed data X1 of the data X is stored in the online storage 104-1, and the distributed data X2 of the data X is stored in the storage unit 117, as shown in FIG. 9.

In FIG. 16, the (application 111 of the) information processing device 101 is set to have received an input of an operation for taking out the information processing device 101 and the re-distributed data of the data X outside the office from the employee (S51).

Furthermore, as described above, it is assumed that designation of each storage location and validity period of the re-distributed data X1′ and re-distributed data X2′ generated by performing re-distribution after restoration of the data X that is classified information has been input thereto, according to the operation in Step S51.

In addition, in regard to the validity period, when the information processing device 101 re-distributes the data x, a display device not shown in the drawing displays (informs of) a message promoting input of the validity period, and an input of the validity period may be received from the user using the operating unit OP.

Accordingly, according to the content input in Step S51, the (access control unit 112 of the) information processing device 101 updates the map table 119 stored in the RAM 118 (S52). Furthermore, although not shown in FIG. 16, the information processing device 101 transmits the intent of having updated the map table 119 to the server 103. In other words, the information processing device 101 instructs the server 103 so as to update the map table 127-1 corresponding to the identification ID of the information processing device 101.

After Step S52, the (server communication unit 116 of the) information processing device 101 transmits an instruction of acquiring the distributed data X1 to the server 103 (S53). The server 103 receives the instruction of acquiring the distributed data X1.

The (storage management unit 125 of the) server 103 acquires the distributed data X1 from the online storage 104-1 according to the instruction of acquiring the distributed data X1 (S54+response). The (information processing device communication unit 121) of the server 103 transmits the distributed data X1 to the information processing device 101 (response).

In addition, the (file system management unit 115 of the) information processing device 101 reads the distributed data X2 stored in the storage unit 117 (S55+response). The (encoding processing unit 113 of the) information processing device 101 performs the restoration process for the data X of the original data based on the distributed data X1 and the distributed data X2 (S56).

Furthermore, the (encoding processing unit 113 of the) information processing device 101 performs re-distribution for the file of the restored data X (S57), and then generates the re-distributed data X1′ and the re-distributed data X2′.

The (file system management unit 115 of the) information processing device 101 stores the re-distributed data X1′ in a predetermined folder of the storage unit 117 (S58), and the re-distributed data X2′ in the external storage medium 105 (S59).

The (server communication unit 116 of the) information processing device 101 transmits the distributed data X2 to the server 103 (S60). The (information processing device communication unit 121 of the) server 103 receives the distributed data X2. The (selector 124 of the) server 103 determines (selects) the storage location of the distributed data X2 referring to the updated map table 127-1.

The (storage management unit 125 of the) server 103 stores the distributed data X2 in the online storage 104-2 according to the output from the selector 124 (S61+response). The (information processing device communication unit 121 of the) server 103 transmits to the information processing device 101 the intent of having the distributed data X2 stored (response). After that, the (file system management unit 115 of the) information processing device 101 deletes the distributed data X2 stored in the (storage unit 117 of the) information processing device 101 (S62),

The (access control unit 112 of the) information processing device 101 updates the take-out flag on the map table 119 from “X” to “O” according to the reception of the response from the server 103 (S63). The above procedure concludes the operation when the information processing device and the file of the re-distributed data are taken out.

Operation when Data Re-Distributed is to be Read After the Information Processing Device and the Re-distributed Data Have Been Taken Out

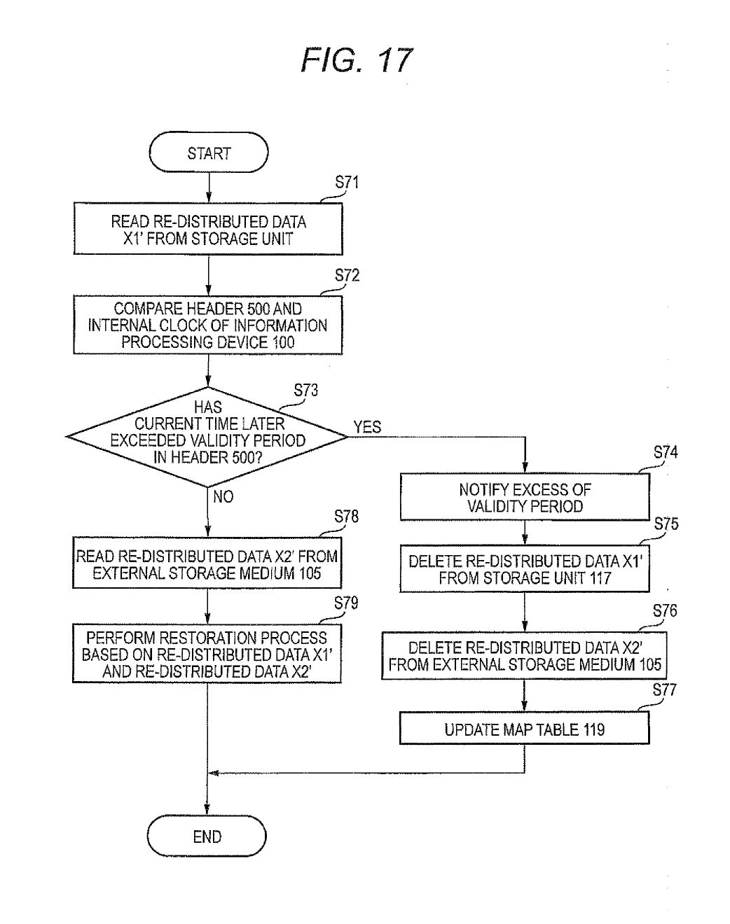

FIG. 17 is a flowchart showing an operation of the information processing device when the data re-distributed is to be read after the information processing device and the file of the re-distributed data are taken out.

In FIG. 17, an example is assumed in which the employee makes use of the file of the data X of the original data using the information processing device 101 and the re-distributed data take outside the office. Alternatively, in FIG. 17, an example is assumed in which the employee has lost the information processing device 101 and the re-distributed data and a third party attempts to use the file of the data X (original data) after acquiring the information processing device 101 and the re-distributed data.

Furthermore, as described above, when the information processing device 101 are taken outside, the file of the data X of the original data has been deleted after the re-distributed data X1′ and the re-distributed data X2′ are generated.

In FIG. 17, the file system management unit 115 reads the re-distributed data x1′ stored in the storage unit 117 therefrom according to the operation using the operating unit OP of the employee or the third party (S71).

The access control unit 112 compares the validity period 504 of the header 500 of the re-distributed data X1′ to an output signal of the internal clock CLK (time information of the information processing device 101) (S72).

Herein, as described above, there are two methods for the validity period, in which, in the case of a predetermined number of days or times, the predetermined number of days or times is added to the creation date or time of the distributed data and the result is compared to the time information of the information processing device 101, and in the case where the validity period is a date or a time, the date or the time is compared to the information processing device 101 without change.

When the current time has exceeded the validity period 504 of the header 500 (YES in S73), the access control unit 112 display a notification that the validity period of the re-distributed data X1′ has exceeded on the display device not shown in the drawing (S74). In addition, when the information processing device 101 is a notebook PC, the display device not shown in the drawing corresponds to the display of the notebook PC.

After Step S74, the file system management unit 115 deletes the re-distributed data X1′ of which the validity period has exceeded from the storage unit 117 (S75). Furthermore, the file system management unit 115 deletes the distributed data X2′ stored in the external storage medium 105 connected to the information processing device 101 (S76).

After Step S76, the access control unit 112 deletes content regarding the re-distributed data X1′ and the re-distributed data X2′ of the map table 119 according to the deletion of the re-distributed data X1′ and the re-distributed data X2′, and updates the map table 119 (S77).

When the current time has not exceeded the validity period 504 of the header 500 (NO in S73), the file system management unit 115 reads the re-distributed data X2′ stored in the external storage medium 105 (578). Furthermore, since the same validity period is set for the re-distributed data X1′ and the re-distributed data X2′ in the validity period 504 of each header 500, the current time does not exceed the validity period 504 of the re-distributed data X2′.

The encoding processing unit 113 performs the restoration process (secret sharing) for the re-distributed data X1′ and the re-distributed data X2′ as described above using the re-distributed data X1′ and the re-distributed data X2′, and then generates a file of the data X of the original data (S79). With the above procedure, the flowchart when the re-distributed data is read after the information processing device and the re-distributed data are taken out ends.

Sequence when the Information Processing Device and the Re-Distributed

### Data are Taken Back

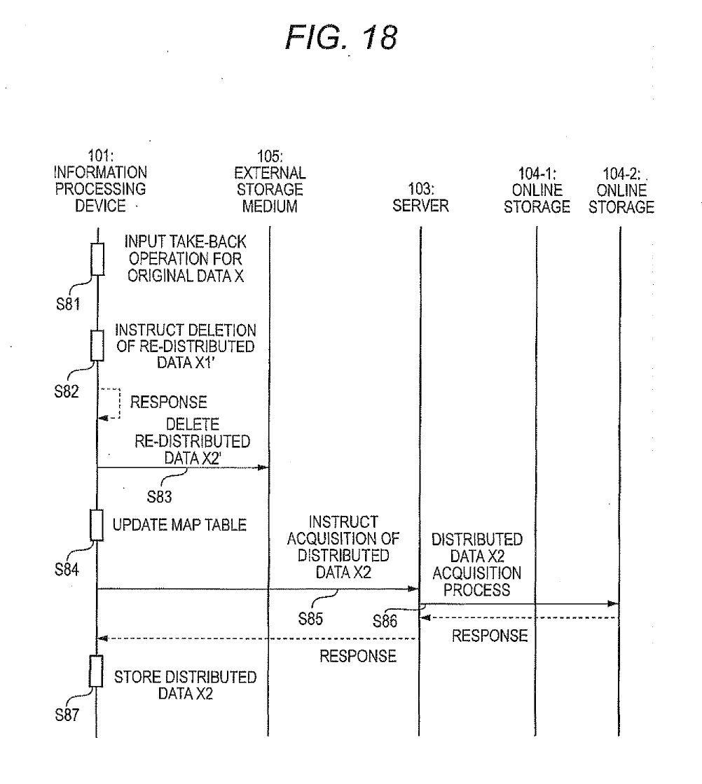

FIG. 18 is a sequence diagram showing an operation of the information processing system 100 when the information processing device and re-distributed data are taken back.

In FIG. 18, a case is assumed in which the information processing device 101 and the re-distributed data that are taken outside the office by the employee (user) are taken back into the office.

In FIG. 18, the (application 111 of the) information processing device 101 is set to receive an operation input for taking back the information processing device 101 and the re-distributed data X2′ of the original data X from the employee (S81).

The (file system management unit 115 of the) information processing device 101 deletes the re-distributed data X1′ of the original data X from the storage unit 117 (S82+response).

Furthermore, the (file system management unit 115 of the) information processing device 101 deletes the re-distributed data X2′ of the original data X from the external storage medium 105 (S83).

After Step S83, the (access control unit 112 of the) information processing device 101 deletes content on the re-distributed data X1′ and the re-distributed data X2′ on the map table 119 according to the deletion of the re-distributed data X1′ and the re-distributed data X2′, and updates the map table 119 (S84).

Since the (server communication unit 116 of the) information processing device 101 stores the distributed data X2 in the storage unit 117 of the information processing device 101, an instruction of acquiring the distributed data X2 is transmitted to the server 103 (S85).

The (information processing device communication unit 121 of the) server 103 receives the instruction of acquiring the distributed data X2. The (storage management unit 125 of the) server 103 acquires the distributed data X2 from the storage location (online storage 104-2) of the distributed data X2 determined (selected) by the (selector 124 of the) server 103 according to the instruction of acquiring the distributed data X2 (S86 response).

The (information processing device communication unit 121 of the) server 103 transmits the distributed data X2 to the information processing device 101 (response). The (server communication unit 116 of the) information processing device 101 receives the distributed data X2 from the server 103.

The (file system management unit 115 of the) information processing device 101 stores the distributed data X2 in the storage unit 117 (S87). Accordingly, after the employee (user) has taken back the information processing device 101 and the re-distributed data X2′ from the outside of the office, the data X of the original data can be used by storing in the information processing device 101 the distributed data separately stored in any online storages and by performing the restoration process (secret sharing) in the encoding processing unit 113.

With the above procedure, even when part (re-distributed data) of the original data X that is classified information is lost or the like, it is possible to effectively prevent the third party from restoring the original data X that is classified information, thereby assuring security of the original data X that is classified information.

In other words, by saving the distributed data X1 and the distributed data X2 in any online storages when the data is taken out and saving the re-distributed data X1′ and the re-distributed data X2′ in each of the information processing device 101 and the external storage medium 105, the original data is not able to be restored with the distributed data in the online storages even when the information processing device 101 or the external storage medium 105 is lost, and therefore, the security further improves than in the past.

Furthermore, since the distributed data X1 and the distributed data X2 that are the original distributed data are stored in the online storages as backup data, even if the external storage medium 105 is lost, the data can be restored by having access to the network.

In addition, by using the re-distributed data X1′ and the re-distributed data X2′ as data in preparation for being taken out, security against take-out can be flexibly changed.

For example, when data is stored in the information processing device 101 and any one of the online storages with the validity period set to 100 days using secret sharing, the intensity of security can be changed by setting the validity period to three days by the common key scheme when the data is taken out.

Furthermore, in the embodiment, the re-distributed data X1′ and the re-distributed data X2′ are set as data in preparation for take-out, but the distributed data X1 and the distributed data X2 may be set data in preparation for take-out. In other words, it is possible to save the re-distributed data X1′ and the re-distributed data X2′ in any one of the online storages, the distributed data X1 in the information processing device 101, and the distributed data X2 in the external storage medium 105.

In other words, by saving each group of the re-distributed data X1′ and the re-distributed data X2′, which is a group that can be restored by the original data X in the same manner as the distributed data X1 and the distributed data X2, which is a group that can be restored with the original data X, separately in the server and the terminal (the information processing device 101 and the external storage medium 105), information security can be assured, and at the same time, back up data in preparation for loss can be established.

Hereinabove, various embodiments have been described with reference to the drawings, but it is needless to say that the present invention is not limited thereto. It is obvious that a person skilled in the art can attain a modified example, an altered example, and further a combined example of the various embodiments within the scope described in the claims, and it is understood that such examples certainly belongs to the technical scope of the invention.

Furthermore, in the above-described embodiments, as types of an encoding process, the common key encryption process and the secret sharing process have been described, but the process is not limited thereto. A public key encryption process, for example, may be used. Furthermore, the secret sharing processing method is not limited to the (2,2) threshold value secret sharing scheme, and other secret sharing processing methods are applicable.

In addition, in the above-described embodiments, a case of taking out data has been described as a use example, but in addition to the case, a case where connection to a general network is made in order to use data, but the network is not available temporarily, or the like, is also included.

This application is based upon and claims the benefit of priority of Japanese Patent Application No. 2011-067765 filed on Mar. 25, 2011, the contents of which are incorporated herein by reference.

### DESCRIPTION OF REFERENCE NUMERALS AND SIGNS

100 information processing system

101 information processing device

102a, 102b network

103 server

104-1, 104-n online storage

105 external storage medium

111 application

112, 122 access control unit

113, 123 encoding processing unit

114, 124 selector

115 file system management unit

116 server communication unit

117 storage unit

118, 128 RAM

119, 127-1, 127-m map table

121 information processing device communication unit

125 storage management unit

129 access log

301, 311 seed value generation part

302, 312 random number generation part

303, 313 encoding process determination part

304, 314 common key encryption part

305, 315 secret sharing processing part

306, 316 common key restoration part

307, 317 secret sharing restoration part

308, 318 header management part

500 header

501 distributed data number

502, 503 encoding scheme

504 validity period

CLK internal clock

OP operating unit

What is claimed is:

1. An information processing device that can be connected to a server and an external storage medium, comprising:
a distribution unit that generates at least two pieces of distributed data from data in a file or a folder;
a restoration unit that restores the data in the file or the folder from at least two pieces of the distributed data; and
a storage unit that stores the distributed data,
wherein, before data take-out, the distribution unit generates first distributed data and second distributed data, and stores the first distributed data in the storage unit and the second distributed data in the server, and
wherein, during data take-out, the restoration unit restores the data in the file or the folder from the first distributed data and the second distributed data, the distribution unit generates third distributed data and fourth distributed data from the restored data in the file or the folder, either the information processing device or the server stores the first and the second distributed data and the other stores the third and the fourth distributed data, and the storage unit in the information processing device stores either one piece of the distributed data and the external storage medium stores the other piece thereof.

2. The information processing device according to claim 1, wherein the first and the second distributed data are stored in the server and the first distributed data is deleted from the storage unit.

3. The information processing device according to claim 1, wherein the first and the second distributed data are stored in the device and the second distributed data is deleted from the server.

4. The information processing device according to claim 1, wherein the distribution unit includes a common key encryption part that generates a common key and encrypted data by encrypting the data in the file or the folder based on the common key and sets the common key and the encrypted data as the distributed data.

5. The information processing device according to claim 1, wherein the distribution unit performs secret sharing for the data in the file or the folder and sets the secretly-distributed data as distributed data.

6. The information processing device according to claim 1, wherein the distribution unit adds a header including a validity period to the distributed data.

7. The information processing device according to claim 6, further comprising an internal clock that measures time of the information processing device, wherein when the time of the internal clock and the validity period of the distributed data stored in the external storage medium are compared to each other, and the time of the internal clock has not exceeded the validity period in the comparison result, the distributed data is read from the external storage medium.

8. The information processing device according to claim 6, further comprising:
an internal clock that measures time of the information processing device,
wherein when the time of the internal clock and the validity period of the distributed data stored in the external storage medium are compared to each other, and the time of the internal clock has exceeded the validity period in the comparison result, the distributed data is deleted from the external storage medium.

9. An information processing system comprising:
an information processing device that can be connected to an external storage medium, including a distribution unit that generates at least two pieces of distributed data from data in a file or a folder; a restoration unit that restores the data in the file or the folder from at least two pieces of the distributed data; a storage unit that stores the distributed data; and a first transmission unit that transmits the distributed data to the server; and
a server that can be connected to the information processing device and a plurality of storage devices, including a second transmission unit that transmits the distributed data to the storage device,
wherein, before data take-out, the distribution unit generates first distributed data and second distributed data, and stores the first distributed data in the storage unit and the second distributed data in the storage devices via the server, and
wherein, during data take-out, the restoration unit restores the data in the file or the folder from the first distributed data and the second distributed data, the distribution unit generates third distributed data and fourth distributed data from the restored data in the file or the folder, either the information processing device or the server stores the first and the second distributed data and the other stores the third and the fourth distributed data, and the storage unit in the information processing device stores either one piece of the distributed data and the external storage medium stores the other piece thereof.

10. A distribution method used in an information processing device that includes a distribution unit that generates at least two pieces of distributed data from data in a file or a folder; a restoration unit that restores the data in the file or the folder from at least two pieces of the distributed data; and a storage unit that stores the distributed data, and can be connected to a server and an external storage medium,
wherein before data take-out, first distributed data and second distributed data are generated, and the first distributed data is stored in the storage unit and the second distributed data is stored in the server, and
wherein, during data take-out, the data in the file or the folder is restored from the first distributed data and the second distributed data, third distributed data and fourth distributed data are generated from the restored data in the file or the folder, either the information processing device or the server stores the first and the second distributed data and the other stores the third and the fourth distributed data, and the storage unit in the information processing device stores either one piece of the distributed data and the external storage medium stores the other piece thereof.

11. The distribution method according to claim 10, wherein the first and the second distributed data are stored in the server, and the first distributed data is deleted from the storage unit.

12. The distribution method according to claim 10, wherein the first and the second distributed data are stored in the information processing device, and the second distributed data is deleted from the server.

13. The distribution method according to claim 10, wherein the data in the file or the folder is encrypted, a common key is generated in order to decrypt the encrypted data, and the distributed data is set to the common key and the encrypted data.

14. The distribution method according to claim 10, wherein the data in the file or the folder is subject to secret sharing and data that has undergone secret sharing is set to distributed data.

15. The distribution method according to claim 10, wherein the distribution unit adds a header including a validity period to the distributed data.

16. The distribution method according to claim 15, wherein when a time of an internal clock in the information processing device and the validity period of the distributed data stored in the external storage medium are compared to each other, and the time of the internal clock has not exceeded the validity period in the comparison result, the distributed data is read from the external storage medium.

17. The distribution method according to claim 15, wherein when a time of an internal clock in the information processing device and the validity period of the distributed data stored in the external storage medium are compared to each other, and the time of the internal clock has exceeded the validity period in the comparison result, the distributed data is deleted from the external storage medium.

18. A program that causes a computer to execute the distribution method according to claim 10.
